(19) United States
(12) Patent Application Publication
(10) Pub. No.: US 2018/0323572 A1
(43) Pub. Date: Nov. 8, 2018

(54) HIGH POWER RAMAN LASER SYSTEM AND METHOD

(71) Applicant: MACQUARIE UNIVERSITY, North Ryde, New South Wales (AU)

(72) Inventors: Richard Paul Mildren, Abbotsford, New South Wales (AU); Aaron McKay, Macquarie Park, New South Wales (AU); David James Spence, North Ryde, New South Wales (AU); David Coutts, Baulkham Hills, New South Wales (AU)

(21) Appl. No.: 15/775,955

(22) PCT Filed: Nov. 18, 2016
(86) PCT No.: PCT/AU2016/051117

§ 371 Date: May 14, 2018

(30) Foreign Application Priority Data
Nov. 18, 2015 (AU) 2015904751

(51) Int. Cl. H01S 3/30; H01S 3/10; H01S 3/042; H01S 3/0915; H01S 3/16; H01S 3/06; H01S 3/105; H01S 3/13

(52) U.S. Cl. CPC H01S 3/30; H01S 3/10092; H01S 3/042; H01S 3/1305; H01S 3/163; H01S 3/0623; H01S 3/105; H01S 3/0915

(57) ABSTRACT

A Raman laser device including: a Raman lasing medium adapted to undergo Raman lasing; and at least one pumping beam, for pumping a Stokes seed beam by stimulated Raman scattering whilst it traverses the Raman lasing medium.

### FIELD OF THE INVENTION

The present invention relates to the field of high average power lasers or amplifiers, and, in particular, discloses a high powered Raman laser or amplifier device.

### REFERENCES

[1] J. Gabzdyl, Nature Photonics 2(1), 21-23 (2008).

[2] Y. Kalisky and 0. Kalisky, Optical Engineering 49(9), 091003 (2010).

[3] N. R. Van Zandt, S. J. Cusumano, R. J. Bartell, S. Basu, J. E. McCrae, and S. T. Fiorino, Optical Engineering 51(10), 104301 (2012).

[4] C. Jauregui, J. Limpert, and A. Tunnermann, Nature Photonics 7(11), 861-867 (2013).

[5] T. Y. Fan, IEEE Journal of Selected Topics in Quantum Electronics 11(3), 567-577 (2005).

[6] S. M. Redmond, D. J. Ripin, C. X. Yu, S. J. Augst, T. Y. Fan, P. a. Thielen, J. E. Rothenberg, and G. D. Goodno, Optics letters 37(14), 2832-2834 (2012).

[7] M. Kienel, M. Mu\ddot{}ller, S. Demmler, J. Rothhardt, A. Klenke, T. Eidam, J. Limpert, and A. Tu\ddot{}nnermann, Optics letters 39(11), 3278-3281 (2014).

[8] S. Wang, M. S. Mangir, and P. Nee, Applied optics 54(11), 3150-6 (2015).

[9] R. J. Williams, O. Kitzler, A. Mckay, and R. P. Mildren, Optics letters 39(14), 4152-4155 (2014).

[10] R. J. Williams, J. Nold, M. Strecker, O. Kitzler, A. McKay, T. Schreiber, and R. P. Mildren, Laser & Photonics Reviews 9(4), 405-411 (2015).

[11] S. J. Pfeifer, Journal of the Optical Society of America B 3(10), 1368 (1986).

[12] M. Smith, D. Trainor, and C. Duzy, IEEE Journal of Quantum Electronics 26(5), 942-949 (1990).

[13] E. J. Divall, C. B. Edwards, G. J. Hirst, C. J. Hooker, A. K. Kidd, J. M. D. Lister, R. Mathumo, I. N. Ross, M. J. Shaw, W. T. Toner, A. P. Visser, and B. E. Wyborn, Journal of Modern Optics 43(5), 1025-1033 (1996).

[14] R. W. Boyd, Nonlinear optics, 3rd edition (Academic Press, 2008).

[15] W. Trutna and R. Byer, IEEE Journal of Quantum Electronics 15(7), 648-655 (1979).

[16] D. Korff, E. Mazur, C. Duzy, and A. Flusberg, Journal of the Optical Society of America B 3(10), 1333-1337 (1986).

[17] E. A. Stappaerts, H. Komine, and W. H. Long, Optics letters 5(1), 4 (1980).

[18] M. Bashkansky and J. Reintjes, Journal of the Optical Society of America B 8(9), 1843-1845 (1991).

[19] D. J. Spence, IEEE Journal of Selected Topics in Quantum Electronics 21(1), 1-8 (2015).

[20] R. Claps, D. Dimitropoulos, V. Raghunathan, Y. Han, and B. Jalali, Optics Express 11(15), 1731 (2003).

[21] A. McKay, R. P. Mildren, D. W. Coutts, and D. J. Spence, Optics express 23(10), 15012-15020 (2015).

[22] R. P. Mildren, A. Sabella, O. Kitzler, D. J. Spence, and A. M. McKay, Diamond raman laser design and performance, in: Optical Engineering of Diamond, edited by R. P. Mildren and J. R. Rabeau (Weinheim Wiley-VCH Verlag GmbH & Co. KGaA, 2013), chap. 8, pp. 239-276.

[23] A. McKay, O. Kitzler, and R. P. Mildren, Laser & Photonics Reviews 8(3), L37-L41 (2014).

[24] J. Murray, W. Austin, and R. Powell, Optical Materials 11(4), 353-371 (1999).

[25] J. Reintjes, R. Lehmberg, R. Chang, M. T. Duignan, and C. G., Journal of the Optical Society of America B 3(10), 1408-1427 (1986).

[26] 0. Kitzler, A. McKay, D. J. Spence, and R. P. Mildren, Optics Express 23(7), 8590-8602 (2015).

[27] G. Boyd, W. Johnston, and I. Kaminow, IEEE Journal of Quantum Electronics 5(4), 203-206 (1969).

[28] J. Goldhar and J. Murray, IEEE Journal of Quantum Electronics QE-18(3), 399-409 (1982).

[29] J. Partanen and M. Shaw, Journal of the Optical Society of America B 3(10), 1374-1389 (1986).

[30] C. Hooker, E. Divall, G. Hirst, J. Lister, M. J. Shaw, and D. Wilson, Physical review 74(21), 4197-4201 (1995).

[31] B. Bobbs and C. Warner, Closed-form solution for second stokes generation in raman amplifiers, in: Proc. SPIE 0642, Modeling and Simulation of Optoelectronic Systems, 127, (1986), pp. 127-131.

[32] R. P. Mildren, Intrinsic optical properties of diamond, in: Optical Engineering of Diamond, edited by R. P. Mildren and J. R. Rabeau (Wiley-VCH Verlag GmbH & Co. KGaA, 2013), chap. 1, pp. 1-34.

[33] F. Peter, Zeitschrift fur Physik 15(1-2), 358-368 (1923). [34] A. Sabella, J. A. Piper, and R. P. Mildren, Optics letters 35(23), 3874-6 (2010).

[36] J. R. Olson, R. O. Pohl, J. W. Vandersande, a. Zoltan, T. R. Anthony, and W. F. Banholzer, Physical Review B 47(22), 14850-14856 (1993).

[37] L. Wei, P. K. Kuo, R. L. Thomas, T. R. Anthony, and W. F. Banholzer, Physical Review Letters 70(24), 3764-3767 (1993).

[38] T. Ruf, M. Cardona, C. S. J. Pickles, and R. Sussmann, Physical Review B—Condensed Matter and Materials Physics 62(24), 16578-16581 (2000).

[39] W. Lubeigt, G. M. Bonner, J. E. Hastie, M. D. Dawson, D. Burns, and A. J. Kemp, Optics letters 35(17), 2994-2996 (2010).

[40] V. G. Savitski, I. Friel, J. E. Hastie, M. D. Dawson, D. Burns, and A. J. Kemp, IEEE Journal of Quantum Electronics 48(11), 1494-1494 (2012).

[41] R. S. Balmer, J. R. Brandon, S. L. Clewes, H. K. Dhillon, J. M. Dodson, I. Friel, P. N. Inglis, T. D. Madgwick, M. L. Markham, T. P. Mollart, N. Perkins, G. a. Scarsbrook, D. J. Twitchen, a. J. Whitehead, J. J. Wilman, and S. M. Wool-lard, Journal of physics. Condensed matter: an Institute of Physics journal 21(36), 364221 (2009).

[42] R. P. Mildren, J. E. Downes, J. D. Brown, B. F. Johnston, E. Granados, D. J. Spence, A. Lehmann, L. Weston, and A. Bramble, “Characteristics of 2-photon ultraviolet laser etching of diamond,” Opt. Mater. Express, vol. 1, no. 4, pp. 576-585, 2011.

[43] Bewley et al, IEEE J. Quantum Electron. 35, 1597 (1999)

[44] Z. L. Liau, “Semiconductor wafer bonding via liquid capillarity,” Appl. Phys. Lett., vol. 77, pp. 651-653, 2000.

[45] D. J. Twitchen, C. S. J. Pickles, S. E. Coe, R. S. Sussmann and C. E. Hall Diamond Rel. Mater. 10, 731-735 (2001).

### BACKGROUND OF THE INVENTION

Any discussion of the background art throughout the specification should in no way be considered as an admission that such art is widely known or forms part of common general knowledge in the field.

Increasing the brightness of high-average power lasers is critical to the development of next generation systems in areas such as aerospace, material processing, environmental sensing and defence [1-3].

The problem of generating high quality laser beams at powers at the 100 kW to megawatt level has been investigated for over 50 years and, indeed, within a few years of the invention laser itself. Chemical lasers have been the most successful to date, with megawatt powers demonstrated and with fair beam quality. However, these systems have a major problem in that they are polluting (producing exhaust gases such as iodine, peroxide, hydrogen fluoride). Also, there is a very limited wavelength choice (1.3 microns for oxygen-iodine lasers which is not eye-safe, and 2.8 microns for HF which has poor atmospheric transmission). There is thus a need for an electrically-pumped laser technology which can ideally produce output at a wavelength that transmits well through the atmosphere and is eye-safe. The most promising solutions so far can be categorized into thin disk lasers, slab lasers and fibre lasers. To date, the maximum power achieved is 10-20 kW before heating of the gain medium significantly deteriorates the output beam quality. Attempts to use active beam processing (adaptive optics) to correct aberrations have had limited application to high powers and beam combination techniques are not yet mature. The use of very long gain media, such as using long active fibres, also represents a limited power scaling strategy due to nonlinear effects such as stimulated Brillouin scattering and thermal effects such as model instability. Furthermore, most work has been done at 1 micron which is not eye-safe.

Beyond 10 kW of average output power, diffraction limited beam quality is challenging to obtain from most gain media due to the increasing influence of nonlinear effects [4].

Coherent beam combining of multiple laser oscillators is a method for scaling diffraction limited beam powers above the single oscillator limit, where the phase of each oscillator is controlled to sub-wavelength precision to achieve a single output beam with a uniform transverse phase [5-8].

Raman beam combining (RBC) is an alternative approach that transfers power from multiple pump beams in a Raman medium to a single Stokes-shifted output beam of high beam quality. This technique is often accompanied by substantial thermal effects that occur in most Raman materials even at modest powers.

Raman beam combining was investigated during the 1980s for scaling the peak brightness of pulsed gas lasers of high pulse energy but low average power [11, 12]. High energy beams demanded large mode volumes in such gas lasers which led to difficulties achieving high quality beams. RBC using a high beam quality Stokes seed beam with multiple phase-correlated high energy pump beams allowed significant advances to brightness scaling in the early development of high-brightness high-energy ultraviolet beams [13]. The requirement for phase-correlated beams was a reflection of the fact that in these experiments, the Raman linewidths were much less than 1 cm⁻¹ which was narrower than the pump and Stokes laser sources.

The gain of a Raman amplifier depends upon the coherent build-up of optical phonons and is a function of the amplitude and phase properties of the interacting beams In many practical instances the phonon field is driven to have the wavevector and phase required for phase-matched transfer of power from the pump to Stokes field. This automatic phase-matching of the Raman interaction, a consequence of the ability for excited optical phonons to carry away any difference in momentum between the input and scattered waves, is responsible for many distinctive advantages compared to many other nonlinear interactions. These advantages include the insensitivity to angle and temperature, the capability to cascade the process to generate higher order Stokes lines and the phenomenon of Raman beam clean up.

Stimulated Raman scattering (SRS) gain properties are straightforward to calculate for single (monochromatic) input and output plane wave fields [14]. However, to achieve near-monochromatic gain, for broadband fields, gain depends upon material dispersion and the details of phase and amplitude correlations between the fields [15-18]. For fields of linewidth greater than the Raman linewidth, it remains only at the level of a monochromatic pump beam if phase fluctuations in the fields are fully correlated during the interaction. Beams must also combine at sufficiently small angles so that the coherence is maintained across the beam's transverse extent [16]. While the beam path lengths must be matched only to within the coherence length (a much weaker constraint than for coherent beam combining) the requirement for correlated pump beams makes the experiment more complex and less flexible for combining off-the-shelf high power lasers. Further complications arise when using multiple non-collinear input beams due to the resulting interference patterns (gain gratings and due to phase-matched four wave mixing (FWM) processes [28,29]). These effects, which depend sensitively on beam crossing angles, may lead to energy loss through off-axis beam generation or degrade the Stokes beam quality. To date, much of the theoretical development has been in the context of gas amplifiers. In the case of Raman crystals, some assumptions can be made to simplify the analysis. Firstly, the pump crossing angles are typically sufficiently large that the effects of gain gratings are negligible [16]. It is also assumed that the angles fall sufficiently away from phase-matching angles for four wave mixing. Finally, the gain for uncorrelated pumps scales according to a correction factor involving the pump, Stokes and Raman linewidths [19], which is near unity for the typical linewidths of crystals and when using many free running pumps. As a result, a Stokes wave of linewidth less than the Raman linewidth is amplified with a gain approximately given by the monochromatic Raman gain coefficient and the average intensity of the pump waves integrated along its path.

It would be advantageous if an effective high powered Raman laser was provided.

### SUMMARY OF THE INVENTION

It is an object of the invention, to provide a high powered Raman laser.

In accordance with a first aspect of the present invention, there is provided a Raman laser device including: a Raman lasing medium adapted to undergo Raman lasing or amplification of a Stokes beam; and at least one pumping beam, for amplification the Stokes beam by stimulated Raman scattering whilst it traverses the lasing medium; wherein the Raman lasing medium is isotropically purified or at a temperature below room temperature.

In accordance with a further aspect of the present invention, there is provided a Raman laser device including: a Raman lasing medium adapted to undergo Raman lasing or amplification of a Stokes seed beam; a Stokes seed beam projected through the Raman lasing medium; and at least one pumping beams, for pumping the Stokes seed beam by stimulated Raman scattering whilst it traverses the lasing medium; wherein the at least one pumping beams can comprise either a multimode input beam or multiple input beams

In some embodiments, the Raman lasing medium can be cooled to cryogenic temperatures. In some embodiments, diamond cooling plates are preferably bonded to the crystalline Raman lasing medium to aid in cooling. The total output power can exceed 1 kW. The crystalline Raman lasing medium can be cooled to cryogenic temperatures.

In some embodiments, multiple pump beams can simultaneously amplify the Stokes seed beam. The multiple pump beams are preferably mutually incoherent. The multiple pump beams are preferably non collinear. The pumping beams are preferably focused on the crystalline Raman lasing medium. The Raman lasing medium can comprise substantially a diamond material. The diamond material can be isotropically of a high purity. The diamond material can have more than 99.99% of one isotope of carbon.

In some embodiments, the multiple pump beams are preferably angularly dispersed around the Stokes seed beam. The pump beams are preferably focused at an angle that avoid loss due to generation of anti-Stokes and higher Stokes beams by four wave mixing. The pump beams are preferably temporally interleaved. The Stokes seed beam and pumping beams are preferably focused on a focal point within the crystalline Raman lasing medium. The Stokes seed beam and pump beams can intersect at an angle substantially larger than the phase matching angle for four wave mixing. The pumping beams are preferably multimode beams The pumping beams are preferably formed from cascading the output of multiple different fiber lasers. The Stokes seed beam and pumping beams can be counter propagated through the crystalline Raman lasing medium. The pumping beams can be projected multiple times through the crystalline Raman lasing medium.

In accordance with a further aspect of the present invention, there is provided a Raman laser device including: a crystalline Raman lasing medium adapted to undergo Raman lasing of a Stokes seed beam; a Stokes seed beam projected through the Raman lasing medium; and at least one pumping beams, for pumping the Stokes seed beam by stimulated Raman scattering whilst it traverses the lasing medium.

In accordance with a further aspect of the present invention, there is provided a Raman laser device including: a crystalline Raman lasing medium adapted to undergo Raman lasing or amplification of a Stokes seed beam; a Stokes wave formed in the Raman lasing medium; and at least one pumping beam, for pumping the Stokes wave by stimulated Raman scattering whilst it traverses the lasing medium; wherein the crystalline Raman lasing medium is isotropically purified or at a temperature below room temperature.

Embodiments of the present invention include, simultaneously:

Using the Raman effect to provide wavelength shifting to an optimal desired wavelength;
Uses the Raman effect to provide beam combination and brightness conversion;
Uses the extremely good thermal properties of diamond to lift the ceiling for thermal effects. The latter is approximately 100-1000 times higher than other materials due to diamond's higher thermal conductivity, and with approx 100 times increase available by using diamond at reduced temperature and a further 100 times by using an isotopically pure diamond.

The embodiments are designed to capture all the necessary steps and approaches to achieve these and in particular to generate beams with power much greater than 10 kW and high beam quality (eg. M²<2)

### BRIEF DESCRIPTION OF THE DRAWINGS

Embodiments of the invention will now be described, by way of example only, with reference to the accompanying drawings in which:

FIG. 1 illustrates schematically the process of offset pump beam focussing within a Raman lasing material in conjunction with a seed beam; The on-axis Stokes seed beam with offset pump beams illustrate the concept of non-collinear diamond Raman beam combining;

FIG. 2 illustrates the effective gain as a function of beam offset b. The inset curves show the transversely-integrated gain as a function of z (in units of z_{R}) in diamond for several beam offsets;

FIG. 3 illustrates the effective gain for N pump beams with equal p for ideally close packed beams on a focusing lens. The insets show selected beam packing patterns with solid lines indicating the 1/e² waist.

FIG. 4 illustrates the phase matching angle for second-Stokes and anti-Stokes generation by degenerate parametric mixing processes. The values are determined using the inset wave vector diagrams and the Sellmeier equations [32, 33].

FIG. 5 illustrates schematically a first embodiment arrangement showing pump and Stokes beam paths;

FIG. 6 illustrates the Pump beam profile incident on the focusing lens (L1). The Stokes seed beam (not shown) is positioned at the center of all three beams;

FIG. 7 illustrates the Pump beam profile imaged from the beam waist in the diamond;

FIG. 8 shows the Raman gain as a function of pump intensity for collinear pump and Stokes seed beams, and for non-collinear pump beams. The lines show fits to the gain equation using the g_{eff} values shown.

FIG. 9 shows the incident (dashed lines) and exit (solid lines) pulses for three non-collinear pumps;

FIG. 10 shows the incident (dashed lines) and exit (solid lines) pulses for the Stokes seed;

FIG. 11 illustrates 110 the temperature dependence of thermal conductivity (solid lines) and thermo-optic coefficient (dashed line) in diamond with 1% (111), 0.1% (112) and 0.001% (113) relative ¹³C isotope concentration.

FIG. 12 illustrates 120 a comparison of thermal susceptibility of isotopically pure diamond to the performance of diamond at room temperature (300 K) with natural isotope concentration (1% ¹³C 121), (1% ¹³C 122), (1% ¹³C 123).

FIG. 13 illustrates the far field Stokes profiles before amplification by three non-collinear pump beams when using a 4.19 kW peak-power seed beam;

FIG. 14 illustrates the far field Stokes profiles after amplification by three non-collinear pump beams when using a 4.19 kW peak-power seed beam;

FIG. 15 is a CCD image capture showing anti-Stokes generation using a 150 mm focal length lens and a single off-axis pump and seed beam. The offset of the anti-Stokes beam from the pump and seed beams is due to the chromatic aberration of the imaging lens.

FIG. 16 illustrates schematically a first alternative arrangement;

FIG. 17 illustrates schematically a second alternative arrangement;

FIG. 18 illustrates schematically a third alternative arrangement;

FIG. 19 illustrates schematically a fourth alternative arrangement;

FIG. 20 illustrates schematically a fifth alternative arrangement;

FIG. 21 illustrates a Raman Laser Cavity arrangement;

FIG. 22 illustrates a diamond with conduction vanes;

FIG. 23 illustrates a Raman Laser Cavity arrangement;

FIG. 24 illustrates the degree of refractive index absorption with respect to wavelength;

FIG. 25 illustrates a comparison of the calculated thermo-optic dn/dT, end-face bulging (n−1)(ν−1) α_{T} and birefringent coefficients (the larger tangential polarization component n³Cϕα_{T} ar shown only) as function of temperature; and

FIG. 26 illustrates the estimated power levels obtainable with the present embodiments.

### DETAILED DESCRIPTION

The embodiments provide for a system and method which provide for a high powered Raman laser device.

Embodiments of the present invention include, simultaneously: using the Raman effect to provide wavelength shifting to an optimal desired wavelength; using the Raman effect to provide beam combination and brightness conversion; using the extremely good thermal properties of diamond to raise the threshold for detrimental thermal effects. The latter threshold is approximately 100-1000 times higher than other materials due to diamond's higher thermal conductivity, and with approx 100 times increase available by using diamond at reduced temperature and a further 100 times by using an isotopically pure diamond.

The embodiments are designed to capture all the necessary steps and approaches to achieve these and in particular to generate beams with power much greater than 10 kW and high beam quality (eg. M²<2).

Crystalline Raman media, have Raman linewidths (1-5 cm⁻¹) which are typically much broader than those of gaseous media and offer the possibility of achieving monochromatic Raman gain with free running solid-state laser beams. Provided that the pump and Stokes linewidths are small compared the Raman linewidth, then the gain remains close to the monochromatic value. This is also the case when using multiple non-collinear pump beams and that have no coherent phase relationship with each other. For diamond, the Raman linewidth is approximately 1.5 cm⁻¹. For beams with similar bandwidth as the Raman linewidth a small gain reduction is observed as described in refs [19-21].

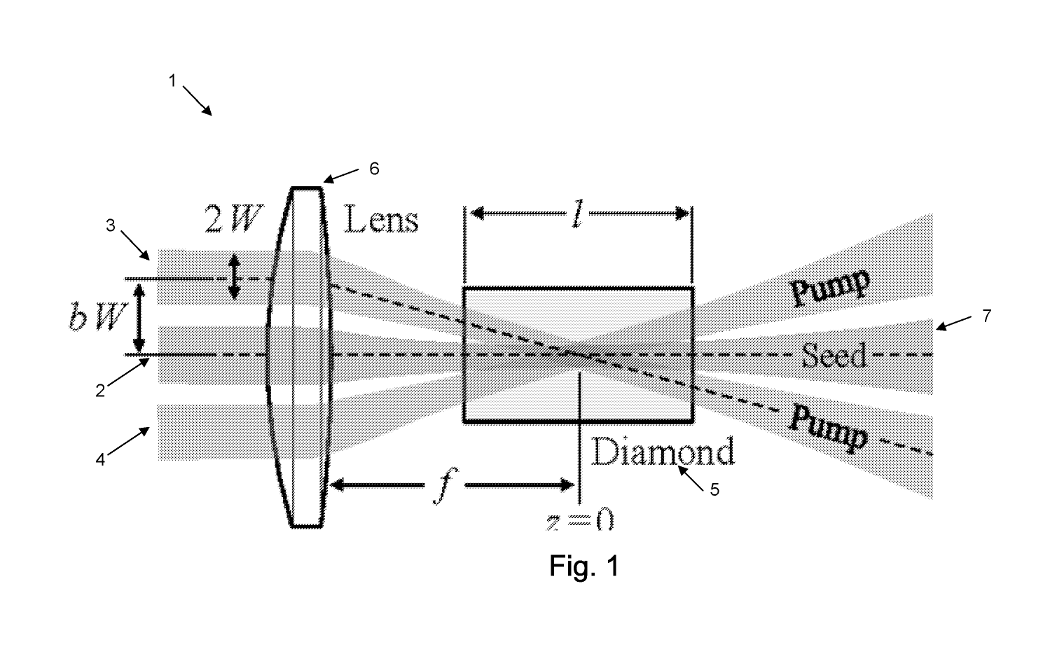

The first embodiment involves a diamond Raman laser, as schematically illustrated in FIG. 1. In this arrangement, an on axis Stokes seed beam 2 is amplified by the effect of offset pump beams 3, 4, which are projected via lens 6 through a diamond crystal 5 which acts as the Raman gain medium, amplifying the seed beam and producing output beam 7.

The utilisation of diamond offers significant advantages for high power Raman beam combination (RBC). A substantial fraction of pump power of beams 2, 3 is deposited as heat in the Raman media 5 due to the inelasticity of the Raman process. This is an intrinsic problem for adapting the RBC process to high average power systems. Diamond provides for a very effective high power Raman medium due to its excellent combination of high Raman gain, low thermal expansion coefficient, high thermal conductivity and moderate thermo-optics coefficient. Diamond Raman lasers with power levels approaching several hundred watts in end-pumped continuous wave oscillators have been recently demonstrated without saturation for durations longer than the thermal time-constant of diamond [9, 10].

There is excellent potential for Raman conversion with high output beam quality at high power levels. This provides for power levels relevant for beam combination of kilowatt class lasers. Furthermore, highly aberrated, multimode beams can been used to pump high-average-power pulsed diamond Raman lasers with high-quality Stokes-shifted output [23]. More than 70% overall brightness improvement has been demonstrated at the tens of watt level despite the intrinsic losses of the Raman shifting process from near 1-micron to 1.48 μm. This process takes advantage of the Raman beam cleanup effect [24]; a process akin to RBC in Raman amplifiers [25].

In some of the following embodiments, the effects of non-collinear RBC from multiple laser oscillators in CVD-grown diamond is utilised to form a high powered laser. The configurations provide for the efficient transfer of power from multiple multimode mutually-incoherent pump beams 3, 4 onto an input seed Stokes beam 5 while preserving the seed beam quality. The multiple beams are close-packed and brought to a focus in a Raman crystal 5 using a single corrected lens 6. Mutually-incoherent pump beams with kilowatt peak powers are used to provide a high power RBC in the steady-state regime. Nanosecond pulses are used to enable investigation of underlying principles that determine efficient RBC (i.e., high fractions of power transfer from multiple pumps to a single Stokes beam) separately from the thermal effects that are important with much longer pulse durations and higher average powers. The gain characteristics of a Raman amplifier pumped using angularly multiplexed beams are calculated and compared to the results with a three-beam input system. The results reveal optimal pumping geometries and power input requirements for high efficiency diamond RBC.

Implementation Considerations

Amplifier Gain in a Non-Collinear Focused Geometry

Stimulated Raman Scattering (SRS) can be considered an automatically-phase matched process, with the k-vector of the driven phonon able to take a range of values as required to couple pump and Stokes beams with any phase and any crossing angle. Thus SRS is essentially independent of the crystal angle or temperature, and means that several pump beams with different crossing angles can be combined onto a single Stokes beam. It also allows pump lasers with low beam quality to efficiently amplify a Stokes beams of higher beam quality [11, 25].

The single pass gain for a Raman amplifier depends on the pump focusing conditions and the mutual overlap of the Stokes and pump beams. The small-signal gain for a Raman amplifier with a single collimated collinear pump beam in the narrow linewidth limit is

G=e^{α}=e^{g}^{₀}^{I}^{_{P}}^{l} (1)

where g₀ is the steady-state Raman gain coefficient, Iₚ is the intensity of the pump beam, and l is the crystal length.

The gain can be conveniently written in terms of the pump power Pₚ as α=gₒPₚl/A_{eff} where A_{eff} describes the transverse and diffractive behavior of the fundamental (pump) and Stokes beams. The effective area A_{eff} is calculated for arbitrary pump and Stokes profiles by integrating the overlap of both beams over the length of the crystal such that:

$$\frac{1}{{A}_{eff}} = \frac{1}{l} {\int }_{- l / 2}^{l / 2} ( {\int }_{ }^{ } {\overline{I}}_{P} ( x , y , z ) {\overline{I}}_{S} ( x , y , z ) dA ) dz \qquad ( 2 )$$

where Īp and Īs are the normalized intensity profiles of the pump and Stokes fields respectively.

For collinear collimated beams A_{eff} is independent of l so that the gain grows exponentially as l increases. In the case of tightly focused collinear beams with zᵣ«l, the effective area becomes proportional to crystal length and the integrated gain on axis is maximized and becomes independent of the length and focusing conditions [19, 21, 26]. For practical beams in a compact Raman amplifier, the exponential gain is determined from the solution of (1) and (2) such that:

$$α = \frac{4 {ng}_{0} {P}_{P}}{{λ}_{S} {M}_{S}^{2} ( \sqrt{1 + η M / R} ) ( \sqrt{1 + η MR} )} \times {tan}^{- 1} ( \frac{l \sqrt{η M / R + 1}}{2 {z}_{R}^{S} \sqrt{η MR + 1}} ) \qquad ( 3 )$$

where η=λ_{P}/λ_{S}, M=M_{P}²/M_{S}² and R=z_{R}^{P}/z_{R}^{S} are the ratios of pump and Stokes wavelengths, beam qualities and Rayleigh ranges. This is the form given by Boyd et al. [27] for gas Raman amplifiers except it has been generalised to allow λₚ to be substantially different to λₛ.

The terms outside of the tan⁻¹ in (3) are an overlap term between normalized pump and Stokes transverse profiles with no reference to the crystal length. The gain dependence on crystal length and development of beams as they propagate through the focus is included within the tan⁻¹ term. For tight focusing, such that the length of the medium is much longer than the Rayleigh range of the beams, the tan⁻¹ term approaches π/2 and the gain is maximized and (3) reduces to:

$$α = \frac{2 π {ng}_{0} {P}_{P}}{{λ}_{S} {M}_{S}^{2} \sqrt{1 + η M / R} \sqrt{1 + η MR}} \qquad ( 4 )$$

which takes a maximum value for matched Rayleigh ranges (R=1).

Equation (4) can be extended for non-collinear beams which cross at a focus by considering a seed Stokes beam propagating along the z-axis interacting with a pump beam centered on the line x=bω₀z/z_{R} (that cross at z=0 and are offset by bω₀ at z=z_{R} and bW at the focusing lens as illustrated in FIG. 1) with matched Rayleigh ranges. The gain is reduced for such angled pumping due to and increase value of A_{eff} from (2). The reduction can be accounted for by using an effective gain coefficient that incorporates the ratio of A_{eff} for non-collinear beams to that for collinear beams, finding that:

$${g}_{eff} = \frac{{g}_{0}}{π} {\int }_{- ∞}^{∞} \frac{{z}_{R} {e}^{\frac{{b}^{2} {z}^{2}}{( {z}^{2} + {z}_{R}^{2} )}}}{{z}^{2} + {z}_{R}^{2}} dz \qquad ( 5 )$$

which has a solution:

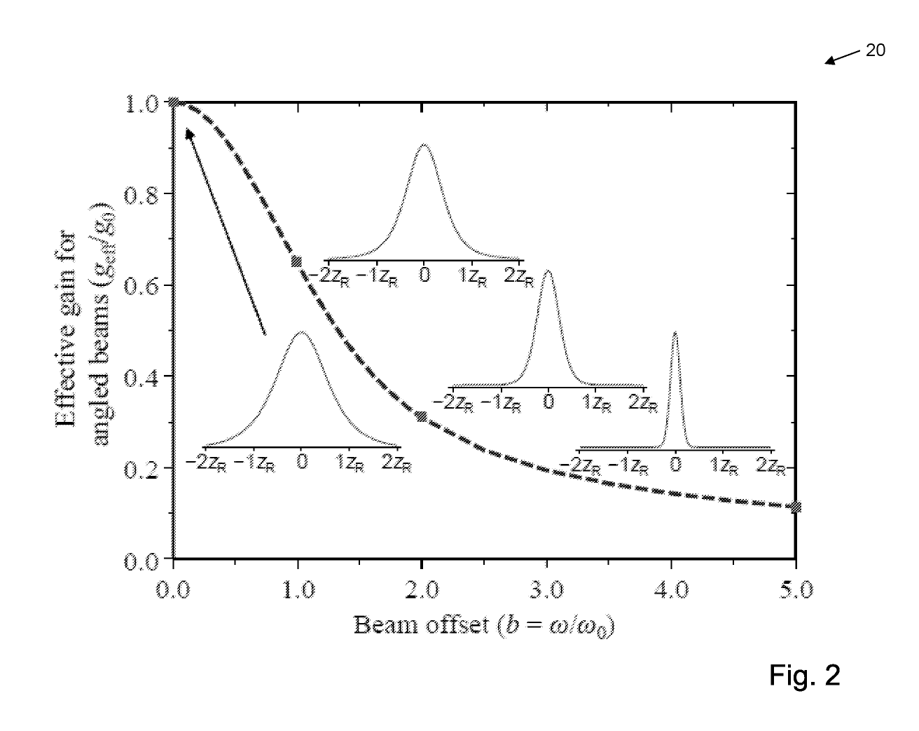

g_{eff}=g₀exp(−b²/2)I₀(b²/2) (6)

where lₒ(x) is the modified Bessel function of the first kind of zeroth order. Equation (6) is independent of z_{R} and dependent only on the beam offset, b as shown in FIG. 2.

The effective gain drops rapidly as the angle of the pump beam increases with respect to the on-axis seed beam, so that for b=1 (the offset giving overlap for two pump beams at the 1/e2 intensity level), the steady-state Raman gain is reduced by g_{erf}/gₒ=0.65 compared to a collinear geometry. The effect of an angled beam is further emphasized by the insets in FIG. 2 which show how the gain evolves as a function of z for several values of b. For larger b, the effective gain length decreases as expected for greater crossing angles.

Provided that the bandwidth of the each pump beam is much smaller than the Raman linewidth in diamond, multiple pump beams can be used simultaneously, each providing gain for the Stokes beam. In this case, the total gain is determined by the sum of g_{eff}Pₚ for all the beams. For angled beams with equal b and equal power, increasing the number of beams N thus increases a proportionally. For arbitrary beam patterns, the expected gain can be calculated by using an averaged value for g_{eff} and the total pump power P_{T} in equation (4). An averaged effective gain coefficient was determined for a range input patterns involving a range of b values.

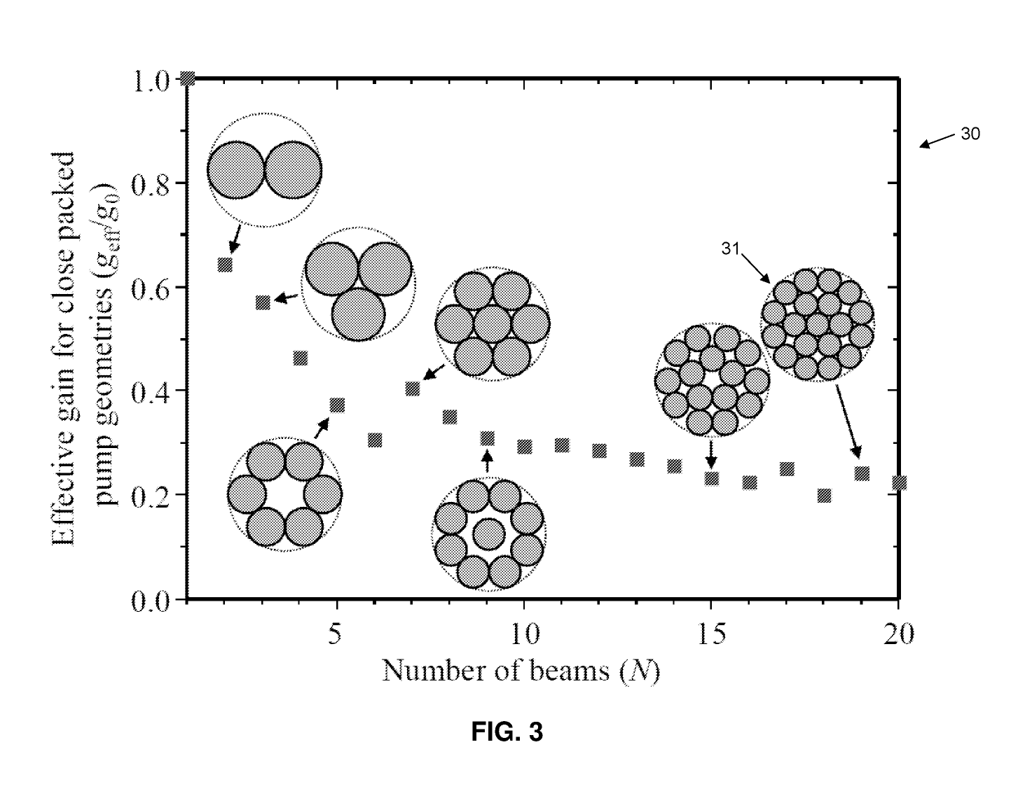

FIG. 3 shows the calculated normalized effective gain coefficient 30 (g_{eff}/gₒ) for a selected range of patterns consisting of up to 20 identical pump beams e.g. 31 with equal power in each beam on a single corrected lens. Each beam has equal intensity and is closely packed with 1/e² intensity levels overlapping with neighbouring beams as shown for selected beam packing geometries in the inset. The effective gain decreases somewhat as more pump beams are combined. This means that a higher-power Stokes seed is required to efficiently deplete the pump beams [21]. These calculations assume that the Rayleigh range for individual beams is much less than the length of diamond crystal in all cases. Diffraction effects in this calculation due to clipping of the pump beams at the 1/e² intensity level have been neglected. These effects would reduce the total pump power transmitted to the diamond (approximately 7.6% of the initial pump power is lost to diffraction for 19 tightly packed beams and approximately 4.3% for 3 beams) as well as the quality of the far field beam as the number of beams increase.

Higher-Order Stokes and Anti-Stokes Generation by Four-Wave Mixing (FWM)

The dynamics of Stokes beam generation requires consideration of the superposition of the pump beams and potential four wave interactions between each pair of modes. For example, amplifier gain can diminish for large bandwidths or for certain propagation angles for which phase-matched wave mixing (FWM) prevails between pump and S fields [24, 28] as well as due to phase-matched generation of higher order Stokes and anti-Stokes fields by FWM.

For maximum conversion efficiency, it is significant to avoid parametric generation of high-order Stokes and Stokes frequencies when using SRS to amplify a Stokes beam with angled beams. Some input pump angles satisfy phase-matching conditions for FWM which diverts power from the beam combining process. FWM generates additional modes that spread power amongst angular placed anti-Stokes and higher order-Stokes lines. In gaseous Raman media the phase matching angle is typically of the order of lmrad, and as much as 10% of the Stokes power can be diverted to second Stokes radiation through the FWM process [30].

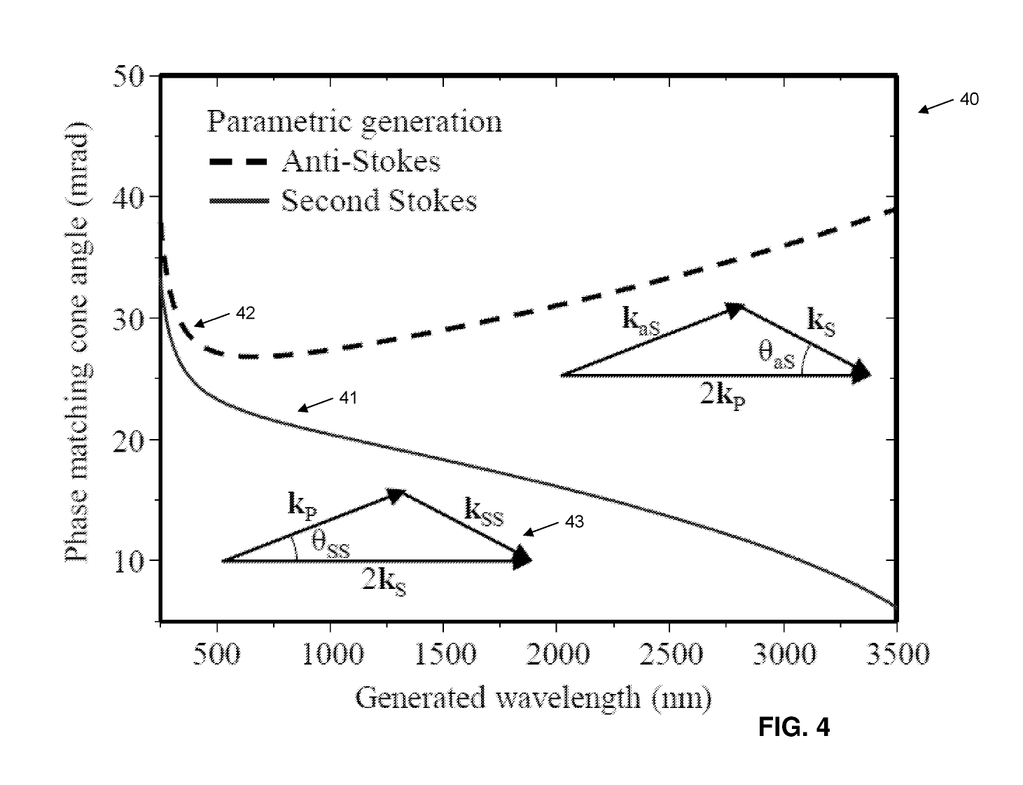

In diamond, the phase-matching angles in the diamond transmission band to 3500 nm are in the range 10-30 mrad are as shown 40 in FIG. 4. The phase matching angle for the second-Stokes 41 and anti-Stokes 42 generation are shown and are generated by a degenerate parametric mixing processes. Values are determined using the inset wave vector diagrams 43, 44 and the Sellmeier equations [32, 33]. Once generated, the second Stokes sees the first Stokes as a pump and will also experience SRS amplification. Indeed if the power of the first Stokes is greater that the saturation power (i.e., the power required to deplete more than 50% of the pump [21]) then the second Stokes can said to be coupled directly to the pump [31], and will strongly compete for pump power with the RBC process. As a result, the combining angles: bW/f should be selected away from the angles shown in FIG. 4, or by using a counter-propagating Stokes beam, in order to mitigate such FWM and for maximum amplifier efficiency. Some packing geometries such as the 9 pump beams of FIG. 3 may have better performance by packing beams around the phase-matching cone angles to prevent higher-order Stokes generation compared to 7 or 8 closely packed beams that have higher amplification factors based on packing density.

Example Arrangements

Various arrangements of Raman beam combining in diamond are possible.

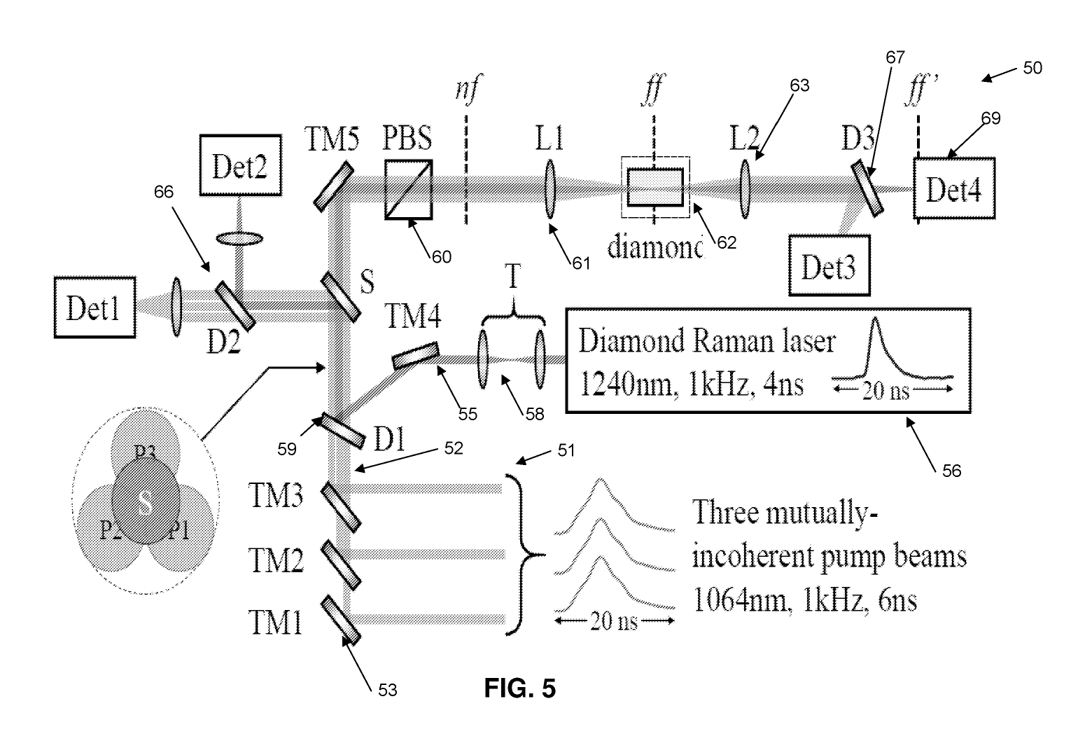

A first example arrangement is as shown 50 in FIG. 5. Three mutually incoherent beams 51 were generated from a single Nd-doped Q-switched laser (with 6 ns pulses at 1 kHz pulse repetition rate) using a series of beam splitters and optical delay lines. The beams were brought together 52 into an array of closely-packed parallel beams.

The calculated gain coefficient, based on measured pump beam displacements (b=1.37) in the near field, was g_{eff}=0.481g₀. The peak power of each pump beam was controlled using sets of waveplates and polarizers to provide peak powers of up to 5.2 kW.

A fourth beam from the pump laser was used to generate a beam 55 at the first Stokes wavelength using a first diamond Raman laser 56, similar to that reported in [34] and optimized for first-Stokes generation at 1240 nm. The output coupling was 60% and more than 80% at second and higher Stokes orders. Peak powers of 20 kW at 1240 nm were obtained in pulses of duration approximately 4 ns (FWHM). A short-pass filter was used to ensure no second Stokes was incident on the amplifier.

The path length difference between each pump and the Stokes beam were arranged to be much longer than the coherence length of the original 1064 nm laser of a few mm, to ensure that the beams had uncorrelated phase noise. This was done in order to mimic pumping of the Raman medium with three separate independent oscillators. The pulse envelopes were still adequately synchronised. A telescope (T) 58 was used to optimize the beam size and divergence of the seed beam. The seed beam was spatially combined with the tiled pump beams using dichroic mirror D1 59. The polarizations of all four beams were aligned to the peak Raman gain axis ((111)) using a polarizing cube (PBS) 60 before impinging on a doublet lens (L1) 61 to focus the beams into a 9.5-mm long diamond crystal 62 (available from Element 6 of the United Kingdom) that was anti-reflection (AR)-coated for 1240 nm. A doublet lens at L1 was used to reduce spherical aberration. A focal length of 75 mm was chosen so that the off-axis pump beams intersected with the seed Stokes beam at focus with an angle substantially larger than the phase matching angle for FWM. The incident and transmitted beams for the pump and Stokes were measured simultaneously. An uncoated wedge (S) 64 and dichroic filter (D2) 66 sampled the pump and Stokes beams before the amplifier 62. After the amplifier, a lens (L2) 63 and dichroic filter (D3) 67 were used to image the far field patterns onto imaging (Ophir SP620) camera and power calibrated photodetectors 69. Calibration was performed over a range of power levels for both the seed and pump beams using a comparison of sensitive power meter measurements and integrated photodiode signals. The effects of shot-to-shot fluctuations (of a few %) were reduced by averaging measurements over several tens of pulses. Each pump beam had a waist diameter of approximately 28 μm with a nominal Rayleigh range of 1.27 mm in the diamond 62 for operation in the tight focusing regime.

The profile of the three beams at focus is shown in FIG. 7, confirming excellent overlap of all three beams at focus. The seed beam had a waist slightly larger (33 μm) thus ensuring good overlap with the superimposed pump profile.

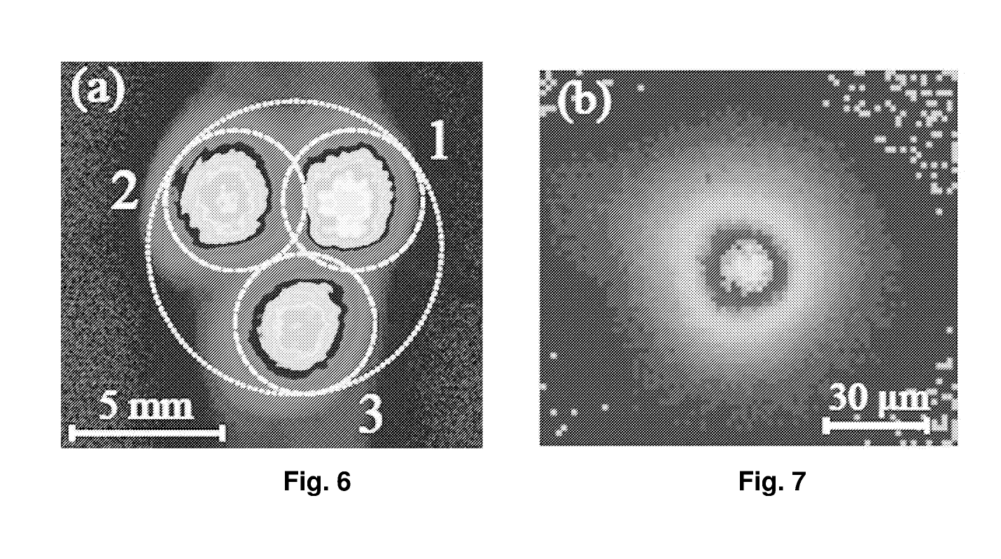

FIG. 6 illustrates the Pump beam profile incident on the focusing lens (L1) 61. The Stokes seed beam (not shown) is positioned at the center of all three beams. FIG. 7 illustrates the Pump beam profile imaged from the beam waist in the diamond.

Experimental Results

Small Signal Gain:

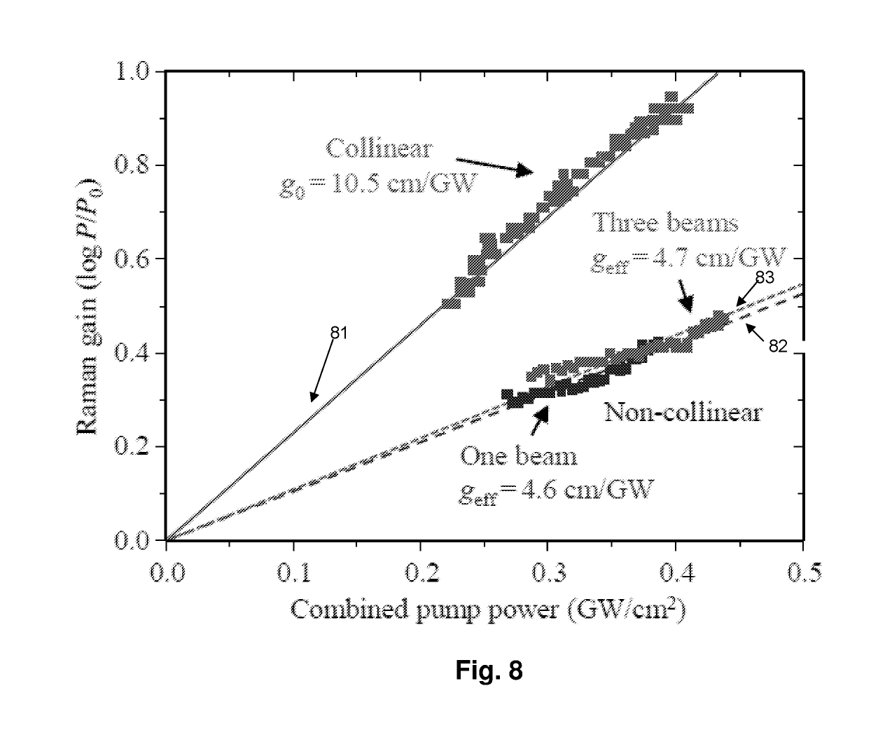

FIG. 8 shows the Raman amplifier gain as a function of pump intensity for collinear pump and Stokes seed beams 81, and for single non-collinear pump beams 82, and three collinear pump beams 83. The lines 81, 82, 83 show fits to the gain equation using the g_{eff} values shown.

By fitting using (3) with g₀ as a free parameter and known experimental parameters, the Raman gain was estimated. Collinear pump and seed beams show strong amplification 81, with fitted parameter g₀=10.5 cm/GW (corrected for the linewidths of the pump, Stokes and Raman mode [19, 20]) with an experimental error of less than 15% based on repeated experiments.

The measured value of g_{eff}/g₀ for a single angled pump beam was 0.46 times lower than for a collinear beam in good agreement with expected value of 0.48 based on (5). This small disparity is perhaps less than expected given the measurement uncertainty in the spacing between the pump beam and central seed beam on the focusing lens (b=1.348), and poorer pump beam quality (from M²<1.1 to M²≈1.2) due to aberrations caused by off-axis pump beams on the doublet focusing lens and diffraction effects from the edges of the D-shaped turning mirrors (TM2, TM3 in FIG. 5). Diffraction patterns on the near-field profiles of all pump beams were observed as shown in FIG. 6.

Combining two additional mutually-incoherent beams with similar beam offset on the focusing lens (b=1.152 and 1.617 for beams 2 and 3 respectively) yields a Raman gain of g_{eff}/g₀=0.47, again close to the single non-collinear pump beam case. The similar gain observed as a function of total pump power demonstrates the additive capability of angular multiplexing pump beams in a Raman beam combiner: the gain depends on the total pump power, and not on whether that power is delivered in a single beam or multiple beams This is a demonstration of efficient RBC of uncorrelated pump beams

Power Amplification

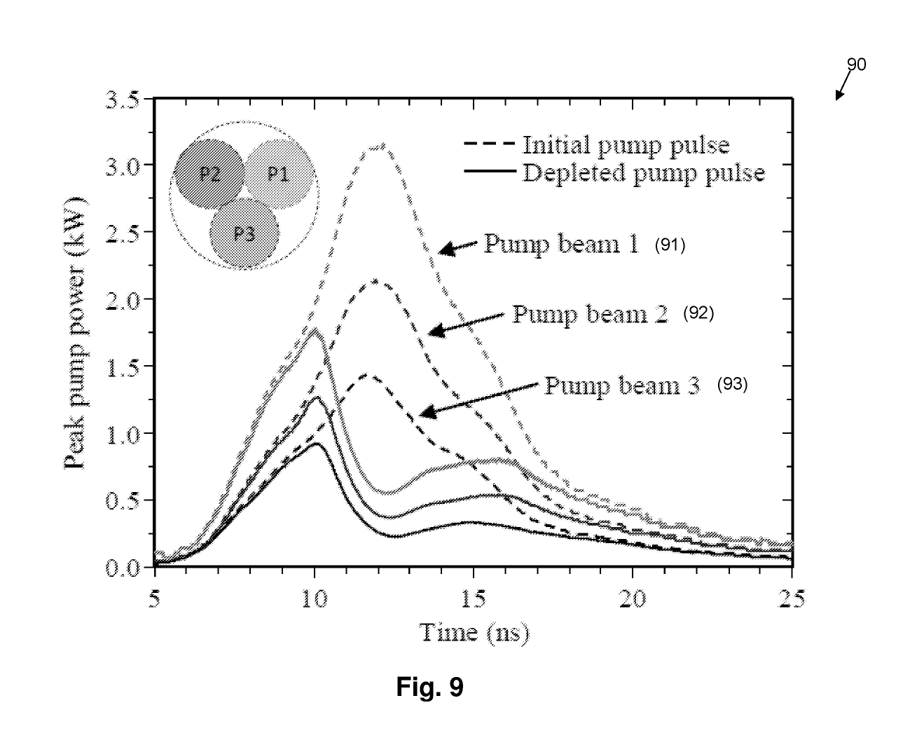

The power transfer from three pump beams into a Stokes seed of peak power 4.19 kW is shown in FIG. 9. Each input pump beam 91-93 was depleted 94-96 by approximately 79.4% (at peak power), regardless of the relative peak power of each pump beam as predicted in [21]. For pump peak powers of 1.44 kW, 2.12 kW and 3.12 kW respectively, more than 5.32 kW of total power was removed from the pumps while approximately 4.58 kW of power gained in the seed. The power difference corresponds almost exactly with the expected loss due to phonon excitation (5.32 kW×(1−λ_{P}/λ_{S})≈0.75 kW). Quantum-limited conversion into 1240-nm radiation was thus observed. The overall combiner efficiency (optical input power to amplified output power) was 69%.

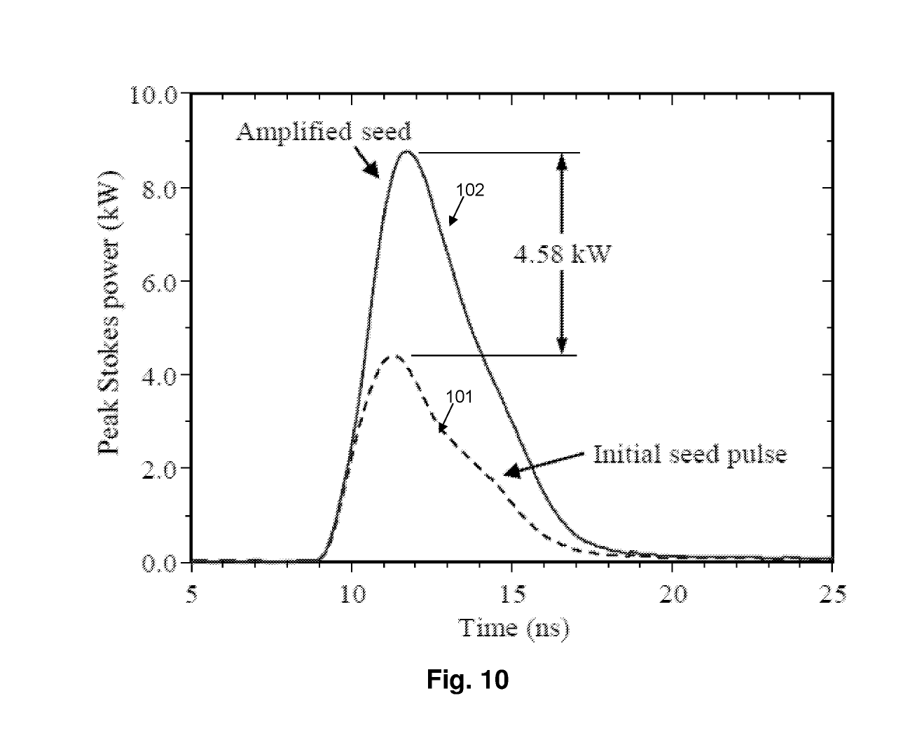

FIG. 10 illustrates the input Stokes seed beam 101 and the resulting output amplified seed 102.

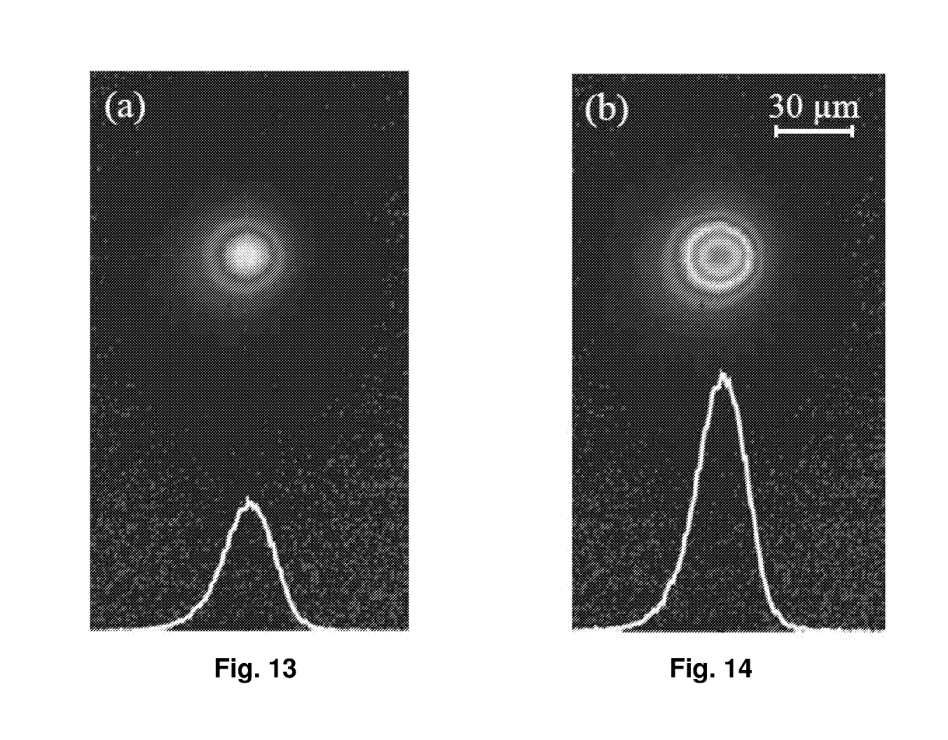

The far field Stokes profiles for before and after the diamond Raman amplifier are shown in FIG. 13 and FIG. 14 respectively. The Stokes profile in the far field was found to maintain its original Gaussian profile.

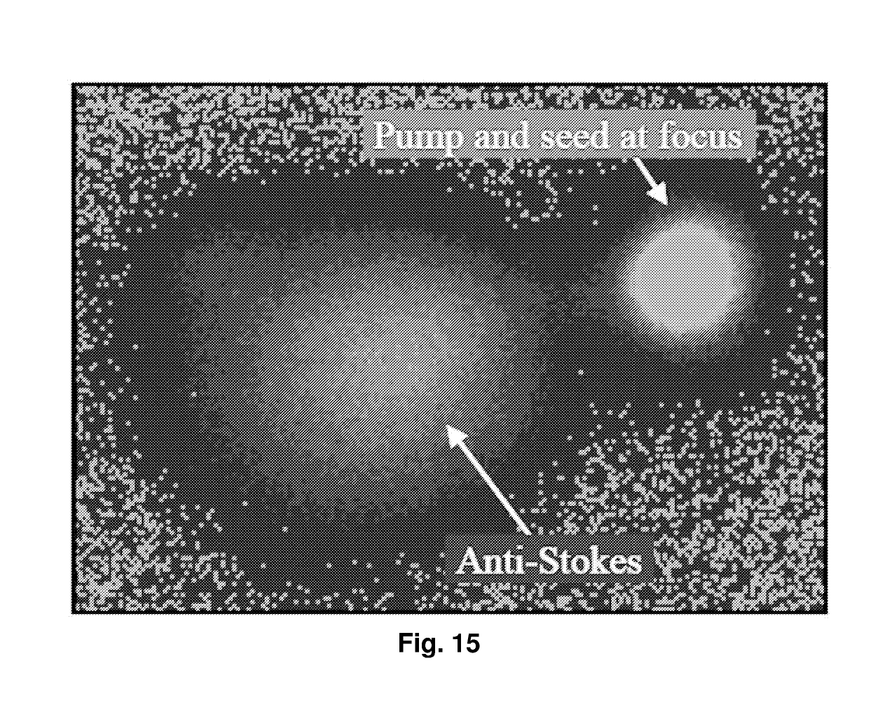

When using, instead, focal lens of focal length 150-mm, the input angles were much closer to the predicted phase-matching anti-Stokes generation. Consequently an anti-Stokes beam was observed on the imaging camera. FIG. 15 illustrates an example of the anti-Stokes beam. A second Stokes power at 1485 nm of intensity comparable to the amplified seed beam from a single pump beam was found. Exact phase matching of the second Stokes is predicted for pump beams with an external angle of approximately 20.1 mrad, which is obtained for the beam geometry using a focal length of approximately 180 mm. When using a 75-mm lens, the second Stokes emission was greatly reduced (less than 5% of first Stokes intensity).

Transferring 4.56 kW of power on to a Stokes beam deposits approximately 760 W into the bulk of the diamond due to phonon decay. Whereas the pulse duration is many times longer than the time to attain steady-state optical phonon field (7 ps dephasing time in diamond), the thermal effects develop over a much longer period (a thermal time constant of ≈10 μs for temperature gradients in a waist radius of approximately 40 μm, and approximately a millisecond to attain a steady-state temperature distribution across the crystal.

Thermally induced stress fractures, birefringence and lensing are important considerations. The deposited power is orders of magnitude below the predicted stress fracture limit of 1 MW [22]. The greatest risk to high average power operation is due to diamonds moderately high thermo-optic coefficient. The fact that a 380 W cw diamond Raman laser has been demonstrated without degradation in slope efficiency and beam quality for periods much longer than the thermal time constant [9], is promising for attaining diamond Raman laser and amplifier average powers in the kilowatt range. Calculations for the lens strength based on the assumption that the heat deposition profile matches the profile for pump depletion were shown recently in [10] to significantly over estimate the thermal lens strength.

Thermally induced stress fracture, birefringence and lensing are signficant considerations. The deposited power is orders of magnitude below the predicted stress fracture limit of 1 MW. For a given heat load P_{dep} in beam of waist ω₀, the thermal lens strength in an isotropic crystal as a result of thermo-optic, end-face bulging and stress-induced birefringence is given by

$${f}^{- 1} = \frac{{P}_{dep}}{2 {πκω}_{0}^{2}} ( \frac{dn}{dT} + ( n - 1 ) ( v - 1 ) {α}_{T} + {n}^{3} {C}_{r , φ} {α}_{T} ) \qquad ( 7 )$$

where for diamond Poisson's ratio ν=0.069, the thermal expansion coefficient and Cr=0.015 and Cϕ=−0.032. The dominant term is predicted to be a consequence of the relatively-high thermo-optic coefficient for diamond. Unfortunately, the fundamental processes responsible for heat deposition are not well understood and as a result calculation of the lens strength has a high uncertainty. For example, making the standard assumption that the heat deposition profile matches the profile for pump depletion has been found to lead to a significant overestimate in the thermal lens strength. The mechanisms for phonon decay, heat deposition and subsequent thermal effects require investigation in order to accurately predict the influence of diamond heating for longer pulse or continuous wave operation. Nevertheless, a 380 W cw diamond Raman laser has been demonstrated without degradation in slope efficiency and beam quality for periods much longer than the thermal time constant.

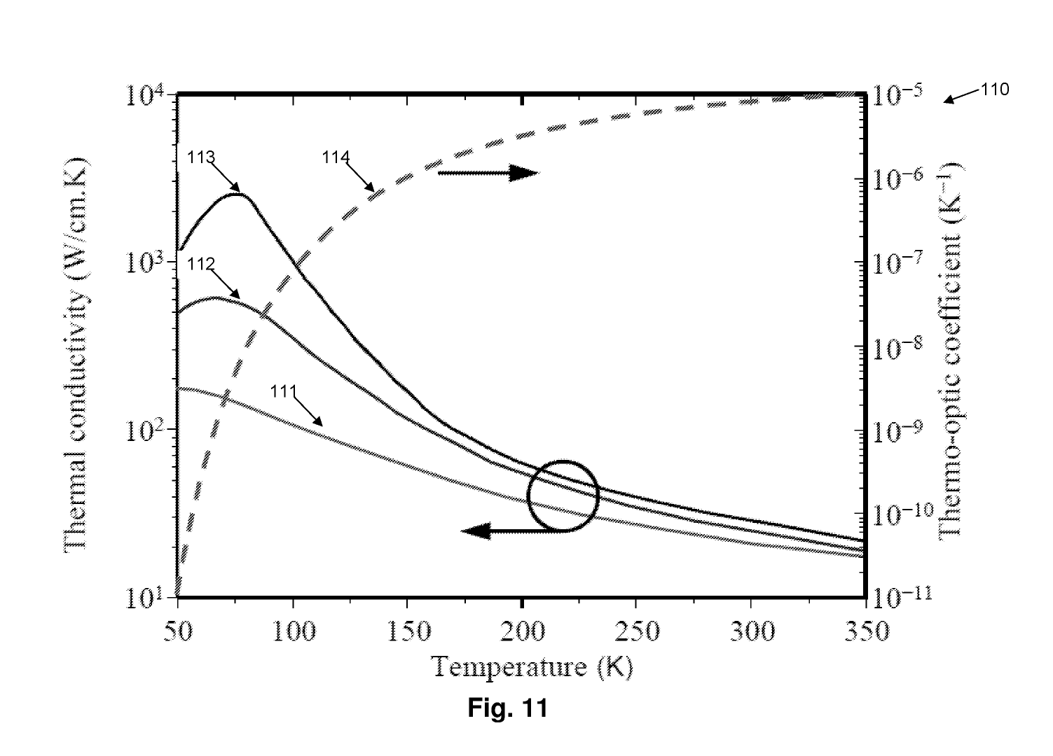

FIG. 11 illustrates 110 the temperature dependence of thermal conductivity (solid lines) and thermo-optic coefficient (dashed line) in diamond with 1% (111), 0.1% (112) and 0.001% (113) relative ¹³C isotope concentration.

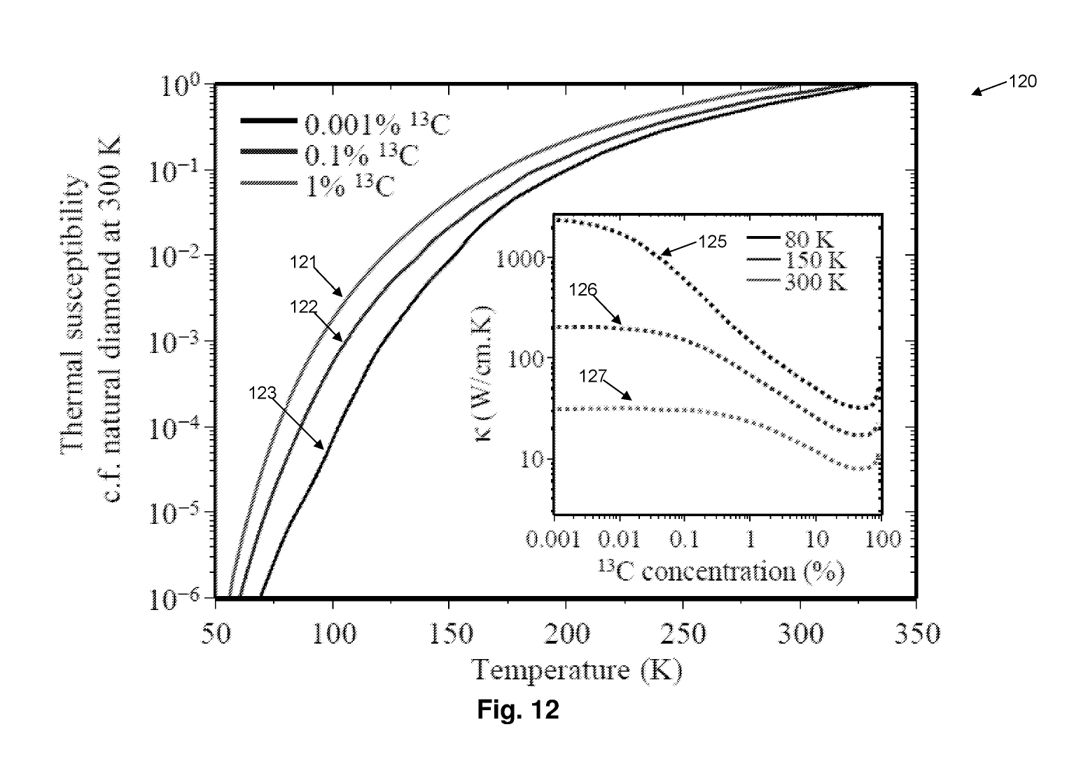

FIG. 12 illustrates 120 a comparison of thermal susceptibility of isotopically pure diamond to the performance of diamond at room temperature (300 K) with natural isotope concentration (1% ¹³C 121), (1% ¹³C 122), (1% ¹³C 123). The thermal susceptibility is defined as (dn/dT)/K: in units of focal length per watt of deposited power. The inset 128 shows the thermal conductivity as a function of ¹³C concentration at different temperatures including 80K (125), 150K 126 and 300K 127. The thermo-optic coefficient is relatively independent of isotope purity.

Despite the significant risk that thermal effects may be important at various power levels, there are several strategies available to mitigate these effects. Isotopically pure diamond and cryogenic operation offer the possibility of very high “thresholds” before detrimental thermal effects in diamond Raman beam combiners become apparent. Although pump and cooling geometry plays an important role, under cw operation the ratio of thermo-optic coefficient to thermal conductivity can be used as a figure-of-merit to describe the thermal susceptibility of a material or how the focal length of the thermal lens develops per watt of deposited power in a given material. This figure of merit has been used to describe the thermal potential of diamond against other common optical and electronic materials, and is used in FIG. 10 to compare the thermal potential of cryogenically-cooled diamond with high isotope purity to room temperature operation of diamond with natural isotope concentrations.

The thermo-optic coefficient (dn/dT) decreases in value for at reduced temperatures. At liquid nitrogen temperatures, the thermo-optic coefficient of diamond in its naturally occurring isotope ratio (¹³C fraction=1.1%) is approximately 1400 times smaller than at 300 K. At 100K it is approximately 110 times smaller than at 300 K. The thermal conductivity also decreases in value as a function of decreasing temperatures. At room temperature with diamond in its naturally occurring isotope ratio has a thermal conductivity of approximately 22 W/cm·K. This value of thermal conductivity decreases as impurities and defects in the diamond lattice increases. At liquid nitrogen temperatures, the thermal conductivity of diamond increases by approximately 7 times compared to at 300K. At 200K, the thermal conductivity is 1.8 times larger than at room temperature.

At liquid nitrogen temperatures, the thermal conductivity is limited by normal scattering processes associated with the small size mismatch of isotopic impurities (rather than the umklapp processes at higher temperatures) [37, 36]. Thermal conductivity in ultra-pure diamond is expected to exceed 2000 W/cm·K [37], and for ¹³C concentrations of 0.001%, more than 4 orders of improvement to the thermal “threshold” is possible. Extreme thermal conductivity with ultra-pure diamond and small thermo-optic coefficients for cryogenic temperatures highlight the prospect of power handling capability well beyond the single oscillator limit in diamond Raman beam combiners.

The table below summarises the thermo-optic coefficient, thermal conductivity and thermal susceptibility of diamond at key temperatures for diamond in its naturally occurring isotope ratio (¹³C concentrations of 1.1%) and isotopically pure diamond with ¹³C concentrations of 0.001%. (Values in the table where compiled from Refs 36 and 37).

| | dn/dT | | κ/ | κ/ |
|---|---|---|---|---|
| Temperature | natural | κ natural | (dn/dT) natural | (dn/dT) pure |
| [K] | [/K] | [W/cm · K] | [W/cm] | [W/cm] |
| 300 | 7.9 × 10⁶ | 21.7 | 3.7 × 10⁶ | 3.7 × 10⁶ |
| 200 | 3.1 × 10⁶ | 38.8 | 1.3 × 10⁷ | 2.2 × 10⁷ |
| 100 | 7.3 × 10⁸ | 110.3 | 1.5 × 10⁹ | 1.9 × 10¹⁰ |
| 77 | 5.8 × 10⁹ | 146.9 | 2.6 × 10¹⁰ | 4.1 × 10¹¹ |

In this initial embodiment, Raman beam combining in diamond, has provided an efficient approach to transfer power from multiple mutually-incoherent beams to a single Stokes-shifted beam with good beam quality. Three angular-multiplexed, mutually-incoherent beams were combined into a single amplified Stokes-shifted beam with good beam quality and an overall power transfer efficiency of 68.5%. More than 79% of each pump beam was depleted by a 4.19 kW peak power nanosecond seed pulse. This embodiment represents a demonstration of Raman beam combining in a crystalline material which is suitable for high average power multimode laser technologies. Using incoherent pump beams, this approach alleviates these constraints imposed by coherent beam combining and earlier gas-based RBC techniques.

These results illustrate beam combining in the Raman steady-state regime, at powers that are accessible by current CW laser technologies.

### Alternative Embodiments

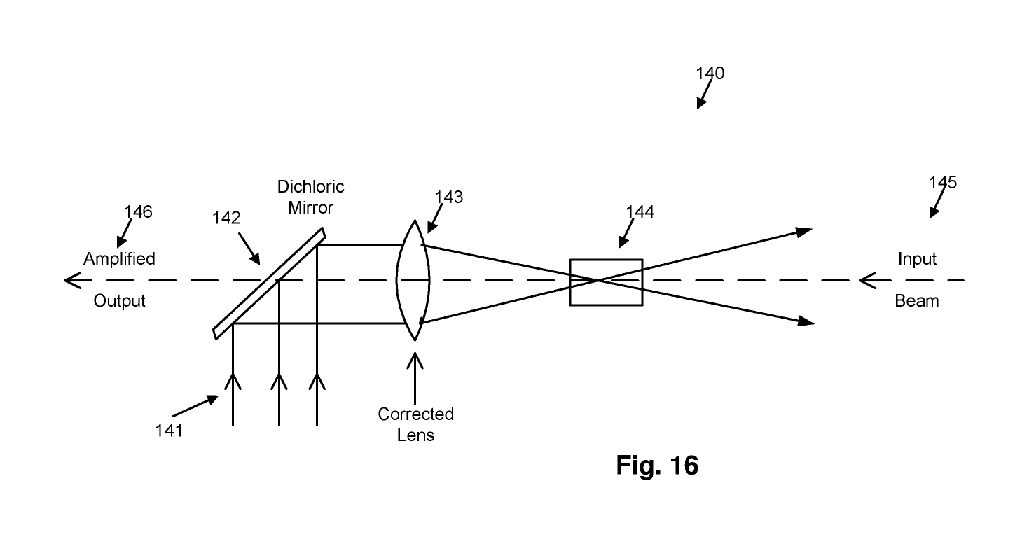

A number of alternative arrangements are possible. For example, FIG. 16 illustrates schematically on alternative arrangement 140 wherein multiple non-collinear pumped beams are input via dichroic mirror 142. The input seed beam 145 is provided in a counter propagating beam. The counter propagating beam reduces the opportunity for parasitic four wave mixing as phase matching is not generally satisfied. Amplified output 146 exits via dichroic mirror 142.

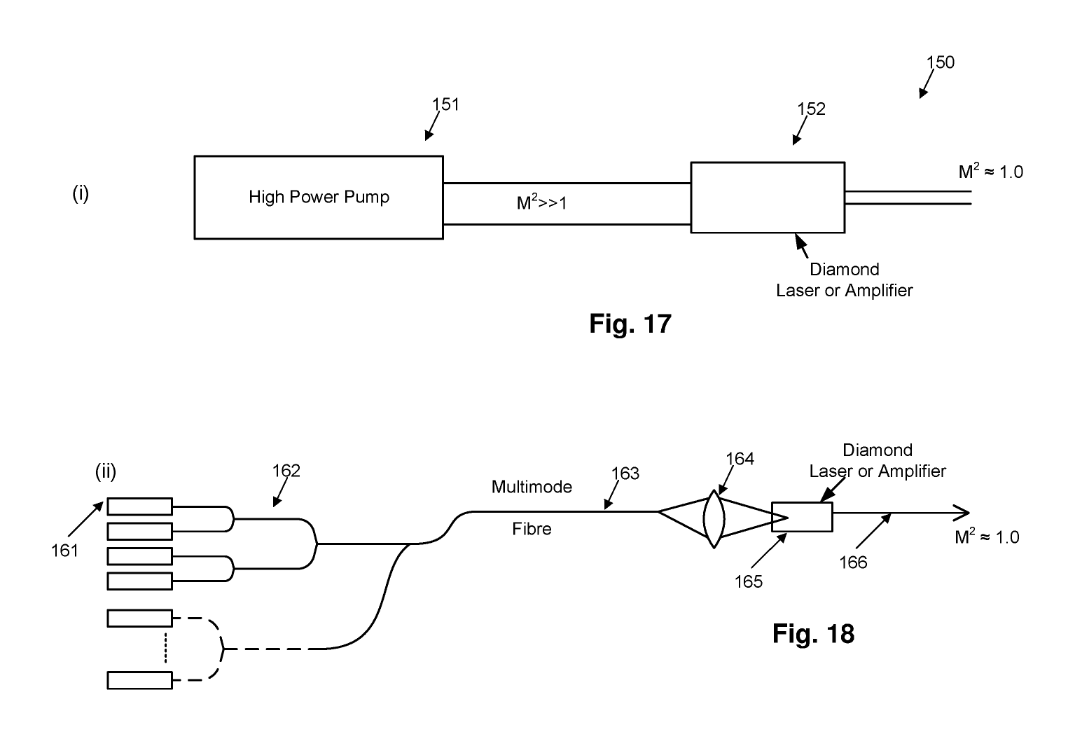

In FIG. 17, there is shown a direct injection arrangement 150, where the high powered laser 151 is directly coupled to diamond amplifier 152 in conjunction with a seed beam.

In FIG. 18, there is shown a further alternative arrangement 160, where the pumping source includes a series of single mode fibre lasers e.g. 161 whose outputs are coupled together 162, to form a high powered output in multimode fiber 163. The coupling could alternatively occur via a photonic lantern arrangement. The output is focused 164, on Diamond Raman Amplifier 166, in conjunction with a seed beam (not shown), to produce amplified output 166. The individual lasers 162 preferably all lie within one Raman linewidth of each other, which can be obtained by them all being derived by amplification of a single master oscillator, but unlike coherent beam combining, there is no need to manage the phase from each of the sources.

In further alternative embodiments, the tree structure may be replaced with a photonic lantern type structure. Ideally, the M squared is preserved as much as possible, so N-single mode fibres can be combined in a single element into an N-mode multimode fibre with high efficiency.

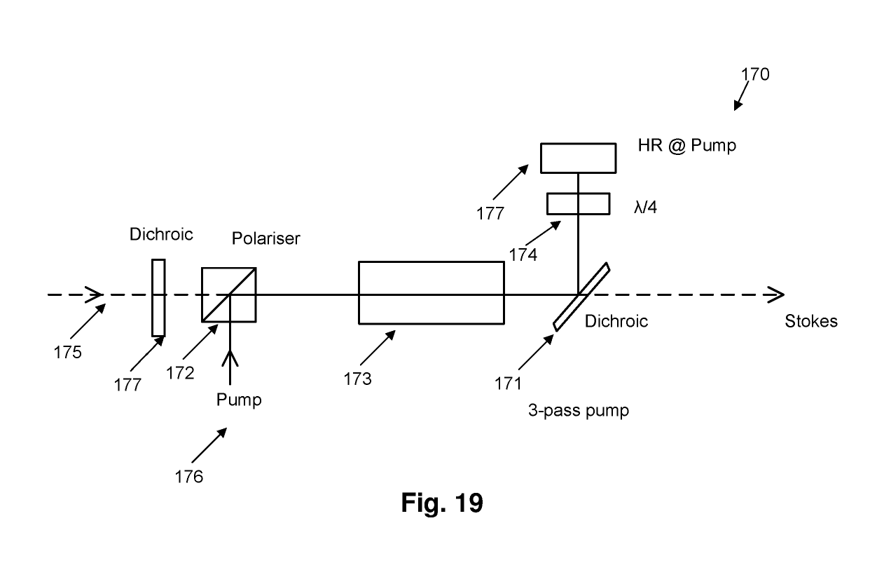

Further alternative embodiments can utilise a multi pass pumped architecture. A first example arrangement which utilises polarisation effects to achieve a multi pass architecture is shown 170 in FIG. 19. In this arrangement, a polarised pump input 176 is first reflected by polarising mirror 172 before being focused into diamond substrate 173, where it amplifies an input seed beam 175. Dichroic mirror 171 transmits the output Stokes beam and reflects the residual pump. A quarter wave plate 174 changes the relative orthogonal polarisation state of the residual pump by 45 degrees reflection by mirror 177, and a second pass through the waveplate 171 and then reflected back through the Raman diamond amplifier for a second pass. The pumped beam is further reflected by dichroic mirror 177 for a third pass through the Raman diamond material. The dichroic mirror 177 can be optional and used where there is good isolation for the pump beam to protect the pump laser from back reflections. In further alternative arrangements, retro-reflectors can be used instead of mirrors. For clarity, the lensing system has not been shown.

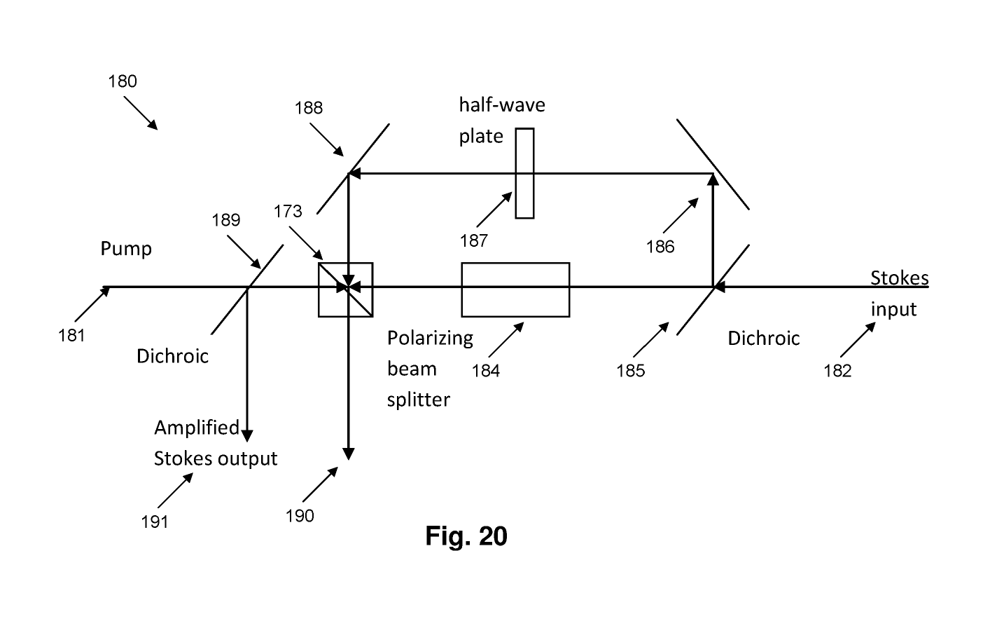

FIG. 20 illustrates a further double pass arrangement 180, where polarised input pump beam 181 is input from the opposite direction from the Stokes seed beam input 182. The pump beam 181 is transmitted through dichroic mirror 189, polarising beam splitter 183, and through Raman diamond amplifier 184. Subsequently, it passes around a loop via dichroic mirrors 185, 186, half wave plate 187, and mirrors 188. Subsequently, it is reflected by beam splitter 183, for another loop around the Raman diamond amplifier 184, before being output 190.

The Stokes input 182, after amplification, is reflected by dichroic mirror 189 and output 191.

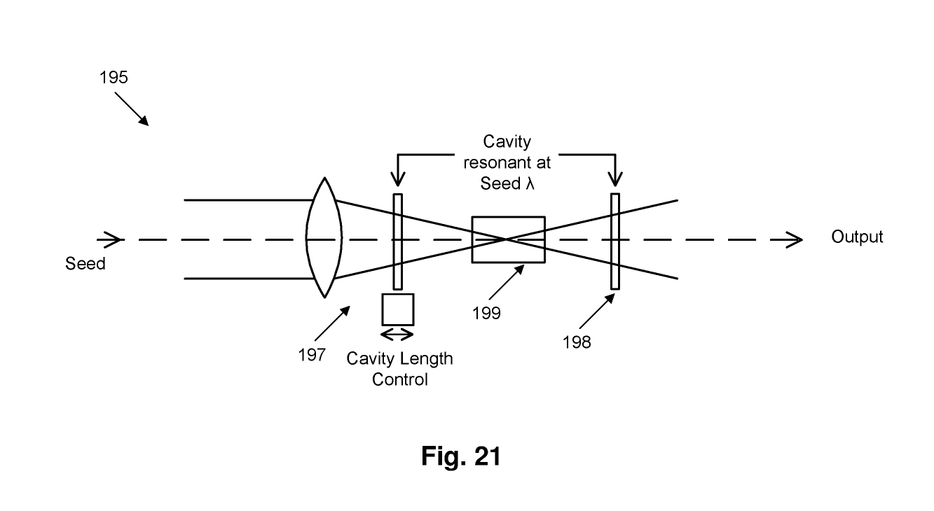

Further arrangements can utilise a resonant amplifier arrangement. FIG. 21 illustrates schematically one such arrangement 195 wherein the seed an input pump beam are input to a resonant cavity formed from dichroic mirrors 198, with the cavity length being adjustable for resonance purposes.

In other arrangements, multi stage amplifiers can be provided wherein the Stokes output from one stage, acts as the seed input to the next stage.

In the arrangements, various polarization schemes can be used. The polarization schemes can also be used in combination with standard polarisation combining of pairs of independent orthogonally polarised pump beams, or with unpolarised pump beams. The favoured polarizations for the pump and seed beams are set out in the attached table:

| Input beam | | | |
|---|---|---|---|
| polarization | Polarization | Seed propagation | |
| type | direction* | direction | Seed polarization |
| Linear | <100> | <110> | <110> |
| | <110> | <110> | <110> |
| | <111> | <110> | <111> |
| | <100> | <100> | <110> |
| | <110> | <100> | <100> |
| Unpolarised | NA | <110> | <110> |
| | | <100> | Any |
| | | <111> | Any |
| Circular | either | <100> | Opposite handedness |
| polarization | | <110> | Elliptically Polarised |
| | | <111> | Opposite Handedness |

For non-collinear pumping, the table specified directions are the ideal directions. In the case of circular polarisation, the pump polarization direction can be either left or right circularly polarized. The seed polarization direction has opposite handedness. In the case of the <110> polarization direction, the seed polarization can be elliptical with opposite handedness to the pump polarization direction. The ellipse has a major axis oriented parallel to <110> with an intensity 1.5 times stronger than the minor axis.

The line width of pump and Stokes beams should be of the order of the Raman line width or less. The laser pump can be pulsed or continuous wave. Pulses can be as short as a femtosec. Synchronous pumping is desired for ultrashort pulse pumping of lasers. The main requirement on the beam quality of pumps is to ensure good spatial overlap of the pump and TEM₀₀ Stokes beams in the diamond.

The preferred diamond specifications can be as follows: Isotopically pure (eg., <0.1% of 12/13C impurity); Cooled temperature (between 80K and 300K); Low defect stress to avoid fracture (beam path through regions with stress<1 GPa as measured by Raman spectroscopy); Coatings should be thin (1-2 microns thick); No oxygen should be present near the crystal to prevent photon-induced surface oxidation

In some arrangements, a Polycrystalline diamond heatsink can be provided to match thermal expansion and for high thermal conductivity. Given the decreasing cost of manufacture of synthetic diamonds, alternative arrangements could utilise a heatsink made of isotopically pure diamond, and using diamond waveguides for high surface to volume ratio, in conjunction with fluid cooling.

In some arrangements, the diamond crystal may be contacted to the heatsink using a thermal paste, such as silver impregnated paste or epoxy, or a metal solder. The diamond surface should be highly polished to reduce the risk of thermal induced stress fracture and to enable the paste of the solder to be as uniformly thin as possible. For the latter reason, the heatsink should be highly polished also. Solder materials such as silver, gold or copper tin alloys, titanium and indium can be used. It may be important to sputter coat the diamond surfaces with a metal layer such as Ti, Ag or Pt, prior to soldering, to improve the strength and integrity of the interfacial contact.

In some cases, it may also be an advantage to use no interfacial medium. In this case, good thermal contact between the diamond and the heatsink can be achieved by ensuring mutually flat surfaces and applying pressure [43] or using a liquid assisted bonding technique [44].

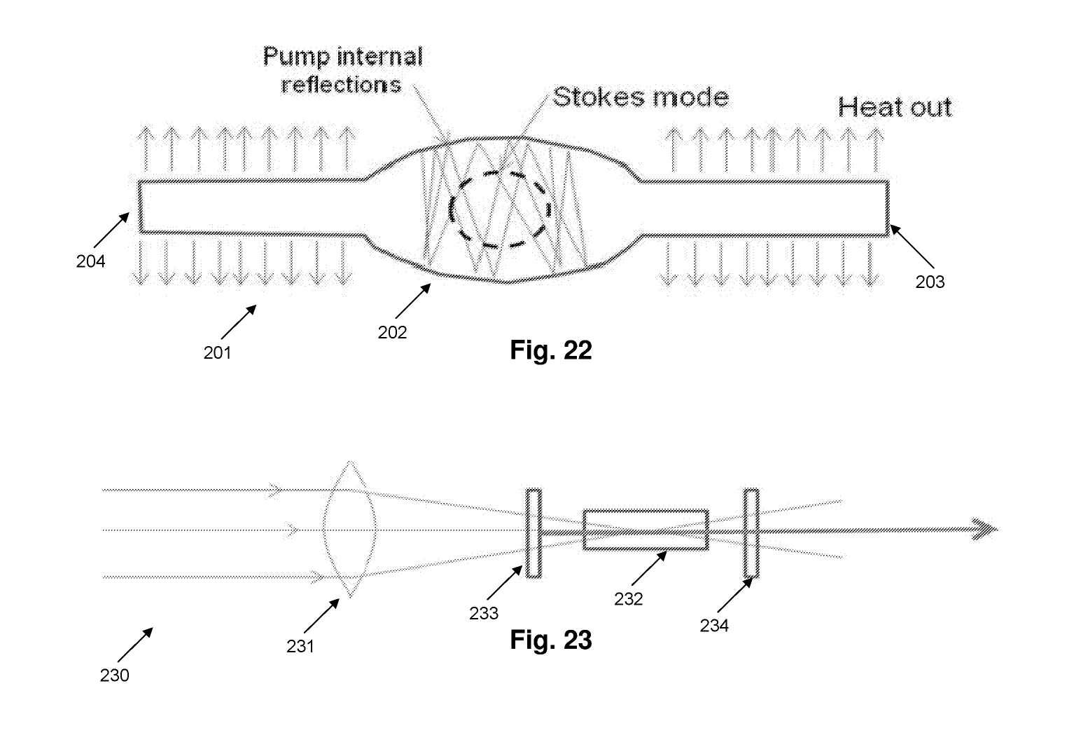

The manufacture of synthetic diamond waveguides provides additional methods for efficient pumping of the Stokes mode volume and enables effective heat removal. The fact that diamond is likely to be the best contact cooling medium introduces challenges for simultaneously providing guidance of the pump beams and cooling of the active region. There will be advantageous geometries that can achieve both. For example, FIG. 22 illustrates 201 an end view of one example arrangement showing an end on view of a fabricated diamond structure having a central Stokes mode area, highlighted by the dashed line, and a series of tabs 203, 204 for the efficient heat transfer. The curved shape of the waveguide 202 is designed to provide internal reflection of the input pump beams through the central Stokes mode area without loss into the the cooling tabs 203, 204.

The embodiments have particular application in the field of cryogenically-cooled diamond Raman beam combiners for applied energy and high power laser applications.

### Diamond Laser Oscillator Design

High power Raman lasers generating high beam quality output may be arranged according to the design shown schematically 230 in FIG. 23. The input pump beams can comprise multiple beams or a single pump beam. The pump beams could be single or multi-spatial modes. The pump beam or beams are focussed into the diamond 232 to achieve intensities greater than the laser threshold. The laser cavity is defined by the two mirrors 233, 234. The cavity curvatures and spacing is designed to achieve good spatial overlap of the TEM₀₀ Stokes mode with the pumped region of the crystal as is known to those skilled in the art. The spacing of mirrors is also designed in order to ensure adequate expansion of the laser mode before it impinges on the mirror so as not to exceed the mirror coating damage threshold.

Mirror coatings should be ultra-loss with a high damage threshold. Ion beam sputtered mirror coatings are an example of a suitable coating technique for producing coatings with high damage threshold for continuous wave operation or for pulse durations longer than 1 microsecond. For example for a 1 MW output beam, the intracavity power may be as high as 50-100 MW which would require the beam size at the mirror to be of the order of 10 cm (diameter) or more to avoid damage. The cavity coatings are selected to achieve output at the selected Stokes order using principles well known to those skilled in the art.

Mirror substrates should be chosen for low absorption loss, high thermal conductivity, and low susceptibility for thermal lensing. Substrates such as low impurity fused silica, SiC, silicon and diamond may be preferential.

Diamond

The diamond could material be from natural sources, grown by chemical vapour deposition or by using the high pressure, high temperature technique. As large beam sizes may be necessary at higher powers, large aperture crystals may be necessary. For the example of a Raman laser of output power 1 MW, beam waist diameters up to several millimetres may be optimal for efficient conversion thus necessitating crystal aperture sizes of the order of 1 cm×1 cm to avoid beam clipping at the crystal edge. The choice of growth method will depend on satisfying simultaneously requirements for aperture size, length, optically and thermally induced stress fracture, low impurity absorption and, depending on the application, low depolarization due to stress-induced birefringence.

Optical Damage of the Raman Medium

Damage may potentially occur to the Raman medium due to optical surface damage or optical bulk damage. Surface damage, due to the laser intensity increasing above the threshold for laser induced damage due to ablation, may be prevented by ensuring the chosen beam areas at the facets are sufficiently large to avoid the threshold being exceeded. In the case of diamond, surface damage due to multi-photon induced ejection of carbon species and which may be prevented by ensuring no oxygen is in contact with the diamond surface by placing the diamond in evacuated vessel or in an oxygen free environment.

The presence of anti-reflection optical coatings on the surface may reduce the damage threshold. The coatings could be applied using techniques such as electron beam sputtering and ion beam sputtering. Ion beam sputtered coatings are suitable for high damage threshold in the continuous wave regime, pulses longer than 1 microsec and pulses shorter than 20 ps.

Diamond should also be selected and prepared to reduce the risk of optical induced stress fractures. Preparation of the diamond with highly polished surfaces without scratches, and with no chipping of corners, assists in reducing this risk. Diamond should also be selected without large internal stresses or absorbing defects. Measurement of internal stress may be achieved through measurements of birefringence and stress-induced shifts in the Raman frequency.

Laser beam propagation through regions of high biaxial stress should be avoided. Regions which show large uniaxial stresses, as evidenced by birefringence maps, should also be avoided.

Where optical coatings are problematic due to the levels of thermal expansion, the diamond can be cut having faces at a Brewster angle. This may provide significant benefits where a cryogenic or cooled design is utilised.

Another important solution to the problem is moth-eye (nano-patterned) anti-reflection surface structure.

Self-Focusing

When scaling to very high power, an effect called self-focusing comes into play which acts to induce a lens in the Raman material due to its electronic nonlinearity (Kerr non-linearity). If this is sufficiently severe it may lead to damage of the Raman medium. It is predicted to occur for beam powers approximately above: P_{critical}=0.15λ²/n n₂

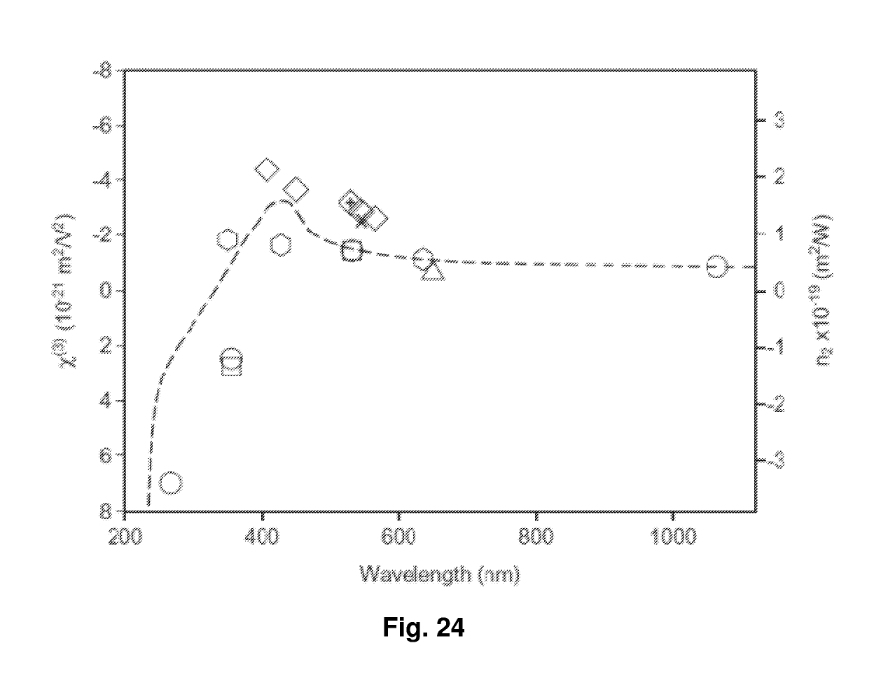

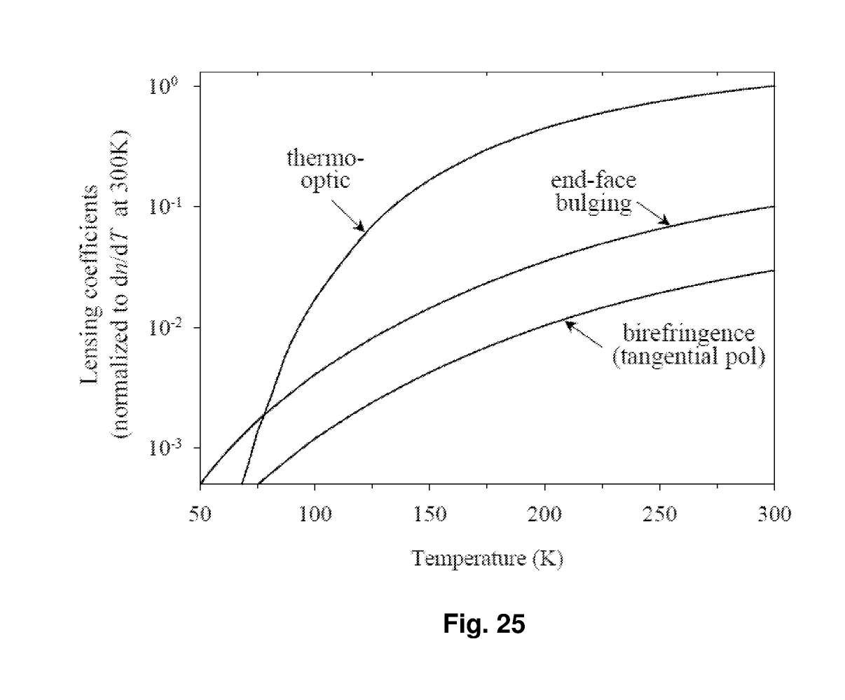

Diamond has a high refractive index n but a relatively low nonlinear refractive index n₂. Thus it is predicted to have a high Pcritical compared to many other materials. For example, at 1.24 microns, the P_{critical} is predicted to be above 2 MW. Nevertheless, the above expression highlights strategies for achieving high power while avoiding self-focusing. These include operation at longer wavelengths (increased λ, and also where n and n₂ are predicted to have reduced values—as illustrated in FIG. 24).

Configurations that minimize the total beam power in the medium are also favoured for achieving very high power. For example, amplifiers or Raman laser oscillators using low quality factor cavities are embodiments that reduce the total beam power in the medium compared to high quality factor oscillators. In cases where some self-focusing is experienced, damage may be avoided by compensating for the focusing by appropriate cavity design (in the case of oscillators) or arranging the input seed beam to have a divergence that prevents focusing within the length of the Raman medium (in the case of amplifiers).

Key wavelengths: The following table shows some important pump laser and operating wavelengths [nm] for the system

| | | Pump | | |
|---|---|---|---|---|
| | Pump laser | Wavelength | First Stokes | Second Stokes |
| 1 | Nd: YAG or Yb: fiber | 1064 | 1240 | 1485 |
| 2 | Yb: fibre | 1018 | 1178 | 1396 |
| 3 | Tm: fibre | 1800-2050 | 2400-2900 | 3500-3900 |
| 4 | Second Harmonic of (1) | 532 | 573 | 620 |
| 5 | Second harmonic of | 546 | 589 | 639 |
| | Yb: fiber lasers | | | |
| 6 | Ho: fibre laser | 2100 | 2950 | — |

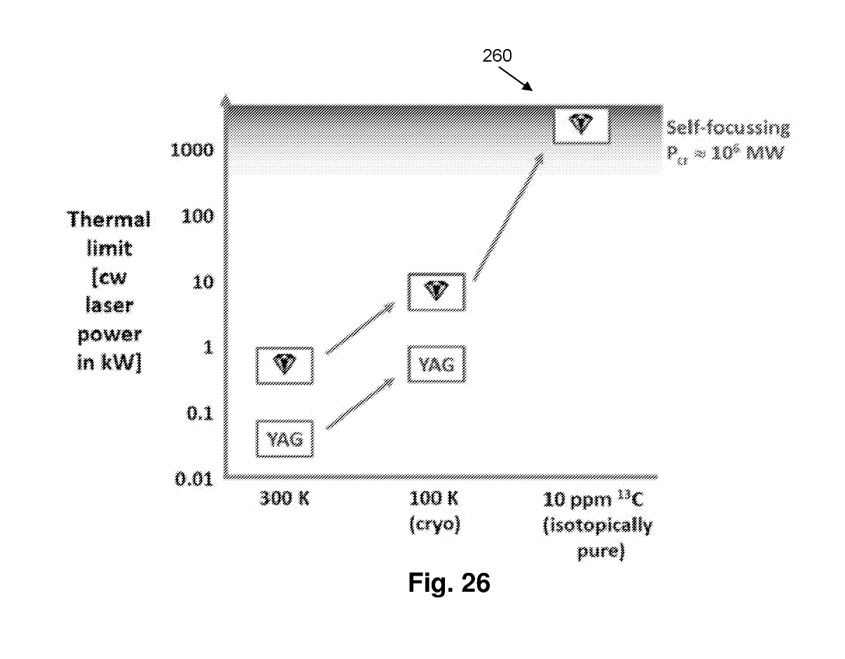

Large reductions in the crystal distortion and birefringence are also anticipated as a result of the approximately Tⁿ dependence of α_{T} where n=3. FIG. 26 shows the contributions of the last two terms in Equation (7) are minor for the temperature range of most interest (77-300 K), only becoming comparable below approximately 60 K. The benefits of reduced temperature are greatly amplified when considering isotopically purified material. Single isotope impurity levels of less than 0.1% have been synthesized previously using chemical vapour deposition [57]. Extraordinarily large increases in κ are available as indicated in FIG. 12, leading to a reduction in thermal susceptibility at the much higher temperature of 125K or a reduction by factor 105 at 77 K. (dn/dT is weakly dependent on the isotopic concentration.) The extremely low thermal susceptibility for isotopically-pure diamond at reduced temperatures high-light the prospect of a power handling capability towards the megawatt range and with thermally unaffected beam quality. The megawatt level has been identified as the point at which Kerr self-focusing is also likely to require consideration [22]. Increasing power to such levels will require proportionally increasing the beam areas in the diamond in order to avoid exceeding the diamond damage threshold. Removing the significant heat load from the crystal (which has a modest surface area typically 1-2 cm² for crystals used to date) can be challenging. However, polycrystalline diamond which has similar thermal conductivity to single crystal [59] and can be readily grown in large thin wafers-provides a scalable avenue for contact cooling the gain crystal and with the added benefit of almost identical thermal expansion coefficient.

The power scaling approach outlined is applicable to a variety of pump lasers including in particular those with output bandwidths not too much greater than the Raman linewidth. The resulting powers, which are assisted by the thermal properties of diamond, are promising for achieving power handling capability well beyond that of any other solid-state laser technology.

Although CW Yb and Nd lasers are initial choices, the approach may also be adapted to address beam conversion in other systems. Beam combination of ultrafast lasers, for instance, may be considered although in this case the effects of self-focusing in the diamond will need to be mitigated. In principle, direct diode pumping is also feasible.

FIG. 26 gives an indication of the resultant potential power levels for a system of the present embodiments, indicating the high power levels potential possible 260.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, figure or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A Raman laser device including:
a Raman lasing medium adapted to undergo Raman lasing or amplification;
a Stokes seed beam traversing the Raman lasing medium;
at least one pumping beams, for pumping the Stokes seed beam by stimulated Raman scattering whilst it traverses the Raman lasing medium;
wherein the at least one pumping beams comprises either a multimode input beam or multiple input beams.

2. A Raman laser device as claimed in claim 1 wherein the Raman lasing medium is isotropically purified.

3. A Raman laser device as claimed in claim 1 wherein the Raman lasing medium is at a temperature below room temperature.

4. A Raman laser device as claimed in claim 1 wherein said Raman lasing medium is cooled to cryogenic temperatures.

5. A Raman laser device as claimed in claim 1 wherein diamond cooling plates are attached to the Raman lasing medium to aid in cooling.

6. A Raman laser device as claimed in claim 1 wherein the total output power exceeds 1 kW.

7. A Raman laser device as claimed in claim 1 wherein multiple pump beams simultaneously amplify the Stokes seed beam.

8. A Raman laser device as claimed in claim 7 wherein said multiple pump beams are mutually incoherent.

9. A Raman laser device as claimed in claim 7 wherein the multiple pump beams are non collinear.

10. A Raman laser device as claimed in claim 1 wherein the pumping beams are focused on the Raman lasing medium.

11. A Raman laser as claimed in claim 1 wherein said Raman lasing medium comprises substantially a diamond material of isotopically high purity.

12. (canceled)

13. A Raman laser as claimed in claim 11 wherein said diamond material has less than 0.01% of isotopes of carbon-12 or carbon-13.

14. A Raman laser as claimed in claim 7 wherein the multiple pump beams are angularly dispersed around the Stokes seed beam.

15. A Raman laser as claimed in claim 7 wherein the multiple pump beams are focused at an angle having low higher order Stokes generation.

16. A Raman laser as claimed in claim 7 wherein said multiple pump beams are temporally interleaved.

17. A Raman laser as claimed in claim 1 wherein the Stokes seed beam and pumping beams are focused on a focal point within the Raman lasing medium.

18. A Raman laser as claimed in claim 17 wherein the Stokes seed beam and pumping beams intersect at an angle substantially larger than the phase matching angle for four wave mixing.

19. (canceled)

20. (canceled)

21. A Raman laser as claimed in claim 1 wherein the Stokes seed beam and pumping beams are counter propagated through the Raman lasing medium.

22. A Raman laser as claimed in claim 1 wherein the pumping beams are projected multiple times through the Raman lasing medium.

23. (canceled)

24. A Raman laser as claimed in claim 1 further comprising coating the Raman lasing medium with a moth eyed anti reflection surfaces.

25. (canceled)

26. (canceled)

27. A Raman laser device as claimed in claim 1 wherein the output spatial beam quality is better than the an input spatial beam quality.

28. A Raman laser device as claimed in claim 1 wherein the Stokes seed beam is formed from spontaneous emission within the Raman lasing medium.

29. A Raman laser device including:
a Raman lasing medium adapted to undergo Raman lasing;
a plurality of pumping beams, for pumping a Stokes seed beam by stimulated Raman scattering whilst it traverses the Raman lasing medium.

30. A Raman laser device including:
a Raman lasing medium adapted to undergo Raman lasing or amplification;
a Stokes wave formed in the Raman lasing medium; and
a plurality of pumping beams, for pumping the Stokes wave by stimulated Raman scattering whilst it traverses the lasing medium.
